(19) United States
(12) Patent Application Publication
(10) Pub. No.: US 2005/0274127 A1
(43) Pub. Date: Dec. 15, 2005

(54) Cryogenic fluid dispensing system

(76) Inventors: Paul Drube, Burnsville, MN (US); Timothy Neeser, Savage, MN (US); Troy Lindquist, New Prague, MN (US)

Correspondence Address: DLA PIPER RUDNICK GRAY CARY US LLP, P. O. BOX 64807, CHICAGO, IL, 60664-0807, US

(21) Appl. No.: 11/093,936

(22) Filed: Mar. 30, 2005

Related U.S. Application Data
(60) Provisional application No. 60/557,775, filed on Mar. 30, 2004.

(51) Int. Cl. F17C 9/02; F17C 13/00

(52) U.S. Cl. 62/50.2; 62/50.7

(57) ABSTRACT

A mobile system for dispensing cryogenic liquid to a use point includes a low pressure bulk tank containing a supply of cryogenic liquid and a high pressure sump in communication with the bulk tank so as to receive cryogenic liquid therefrom. A check valve is in circuit between the bulk tank and the sump. A heat exchanger is in communication with the sump and selectively receives and vaporizes a portion of cryogenic liquid from the sump when the sump is full as detected by a liquid level sensor. The resulting vapor is directed to the sump so as to increase the pressure therein. The check valve closes when the pressure building within the sump is initiated. The pressurized cryogenic liquid is dispensed from the sump via a dispensing hose. Operation of the system valves is automated by a controller.

### CLAIM OF PRIORITY

This application claims priority to U.S. Provisional Patent Application Ser. No. 60/557,775, filed Mar. 30, 2004, currently pending.

### BACKGROUND OF THE INVENTION

The present invention generally relates to delivery and dispensing systems for cryogenic fluids and, more specifically, to a mobile cryogenic liquid dispensing system that allows for dispensing of cryogenic liquid directly to a use point without the use of a pump.

Cryogenic liquids are typically stored in thermally insulated tanks which consist of an inner storage vessel mounted within, and thermally isolated from, an outer shell. In addition, cryogenic liquids are usually dispensed from a bulk supply tank to smaller storage cylinders for use in various applications including industrial, medical and research processes.

Oftentimes, the cryogenic liquid bulk supply tank remains stationary and the storage cylinders are transported to the bulk supply, refilled and transported back to the use site, such as a plant, hospital or laboratory. The structural reinforcements required to ensure durability of transportable storage cylinders, however, provide additional heat conduction paths and increase the heat in-leak to the stored cryogen. In addition, transporting the tanks can be costly.

As a result, there have been efforts to utilize stationary, on-site storage cylinders, which provide more insulation against heat in-leak. These stationary cylinders are refilled from a transportable bulk supply tank, which may be mounted on a truck, trailer or other type of vehicle. A variety of mobile delivery and dispensing systems currently exist for providing cryogenic liquids to storage cylinders at the use point.

One type of mobile delivery and dispensing system is the HLD series manufactured by Chart Industries, Inc. of Cleveland, Ohio, the present assignee. The system features a high pressure bulk tank mounted on the delivery vehicle. The bulk tank is equipped with an external heat exchanger that acts as a pressure-builder and pressurizes the bulk tank to a transfer pressure when the vehicle arrives at a use point. The bulk tank must be mounted on the vehicle, however, in a generally horizontal orientation which results in a large liquid surface area beneath the tank head space. This makes pressure-building very difficult as the vapor from the heat exchanger tends to be condensed by the large liquid surface area. As a result, the system operator must wait a long time for pressure to build which results in long delivery times.

Upon completion of the fill, the system is disconnected from the receiving tank. The bulk storage tank then must be vented to atmosphere prior to movement to prevent condensation of the added warmer vapor to the liquid cryogen so that further heating of the liquid is avoided. Venting may also be necessary to reduce the tank pressure to transport levels required by Department of Transportation regulations. Venting of the bulk tank is undesirable as it takes additional time, decreases the amount of product available for distribution and increases waste.

A further disadvantage of such a system is that the entire contents of the bulk tank are heated even though only a portion is dispensed. This decreases the hold time of the tank which results in increased vent losses. Furthermore, the high pressure contained by the bulk tank requires that it have very thick inner walls which increases the system expense and weight.

An alternative to the above high pressure system is the HL series system, also manufactured by Chart Industries, Inc. of Cleveland, Ohio. The system features a low pressure bulk tank mounted on a vehicle such as a delivery truck. A pump is also mounted on the vehicle and transfers cryogenic liquid from the bulk tank to the use point. A disadvantage of such an arrangement, however, is that the pump is exposed to ambient air and temperature. As a result, the pump must be equipped with seals that have high maintenance requirements. In addition, the pump must be cooled down prior to use or else two-phase flow of cryogen will occur in the pump and damage it. Pump cool down is accomplished by transferring liquid cryogen to the pump and allowing the pump to cool for a period of time which may be anywhere between five and thirty minutes. This results in a significant delay before dispensing may take place.

A more recent type of mobile delivery and dispensing system is illustrated in commonly assigned U.S. Pat. No. 5,954,101 to Drube et al. The Drube et al. '101 patent discloses a vehicle-mounted dispensing system including a low pressure vacuum-insulated bulk storage tank that feeds cryogenic liquid to a vacuum-insulated sump containing a pump. As a result, the pump is submerged in liquid cryogen and pre-cooled. When use of the system is initiated, cryogenic liquid from the pump is directed to another sump containing a meter. Cryogenic liquid is recirculated through the meter sump back to the bulk tank by the pump as the meter cools down. A resistance temperature device measures the temperature of the cryogen in the meter sump and signals the operator via a controller when the meter reaches operating temperature. The operator then presses a button which redirects the cryogenic liquid from the pump through the meter and out a dispensing hose.

The system of the Drube et al. '101 patent is effective in eliminating two-phase flow through the pump and meter, and thus permits accurate metering. In addition, because the pump is submerged in liquid cryogen, there are no pump seals to maintain and no pump cool down time is required prior to dispensing. The meter sump does not contain liquid cryogen, however, when the system travels between dispensing locations. As a result, the meter must be cooled down which causes a delay prior to dispensing. In addition, the pump, the electrical generation system, recirculation piping and meter sump add to the size, weight, complexity and expense of the system. The pump and electrical generation system also adds maintenance and operating costs to the system. A further disadvantage is that such a system can't be used to dispense liquid oxygen. This is because the electric pump motor and electrical feeds cannot be submerged in liquid oxygen in the sump due to ignition concerns.

A need therefore exists for a system that combines the advantages of a low pressure bulk storage tank with a smaller, vertically-oriented high pressure sump for rapid pressure building. In addition, a need exists for a system that can dispense cryogenic liquid without the use of a pump.

Accordingly, it is an object of the present invention to provide a mobile cryogenic liquid delivery and dispensing system that features a low pressure bulk storage tank.

It is another object of the present invention to provide a mobile cryogenic liquid delivery and dispensing system that features a sump within which pressure building may be rapidly accomplished.

It is another object of the present invention to provide a mobile cryogenic liquid delivery and dispensing system that does not require a pump.

It is still another object of the present invention to provide a mobile cryogenic liquid delivery and dispensing system that is easy to operate.

It is still another object of the present invention to provide a mobile cryogenic liquid delivery and dispensing system that is economical to construct.

These and other objects and advantages will be apparent from the following specification.

### SUMMARY OF THE INVENTION

The present invention is directed to a mobile system for dispensing cryogenic liquids that includes a low pressure bulk tank containing a supply of cryogenic liquid. A sump receives cryogenic liquid from the bulk tank through a strainer and a supply check valve. A vent return line extends between the bulk tank and a pipe is in circuit between the supply check valve and the vent return line. The vent return line includes a valve and the pipe includes a number of apertures through which the cryogenic liquid enters sump. When the liquid level in the sump covers the top-most aperture of the pipe, vapor may no longer be displaced from the sump through the vent return line and the transfer of liquid into the sump is terminated.

A liquid level sensor determines that the sump is full and signals a controller which closes the vent return valve and opens a pressure building valve so that a portion of the liquid from the sump is directed to a heat exchanger. The resulting vapor is directed to the head space of the sump so that the pressure in the sump increases to a delivery pressure. As the pressure in the sump begins to build, the supply check valve closes. When the delivery pressure is reached, a pressure sensor signals the controller which then opens a dispensing valve so that dispensing may commence.

When the liquid level drops to a predetermined level, the controller automatically closes the dispense valve, opens the vent return valve and a sump vent valve that vents the sump to atmosphere. As a result, the supply check valve opens and the sump is rapidly refilled with cryogenic liquid from the bulk tank.

The following detailed description of embodiments of the invention, taken in conjunction with the appended claims and accompanying drawings, provide a more complete understanding of the nature and scope of the invention.

### BRIEF DESCRIPTION OF THE DRAWINGS

FIG. 1 is a side elevational view of a first embodiment of the cryogenic fluid dispensing system of the present invention;

FIG. 2 is a front elevational view of the cryogenic fluid dispensing system of FIG. 1;

FIG. 3 is a rear elevational view of the cryogenic fluid dispensing system of FIG. 1;

FIG. 4 is a schematic view of the cryogenic fluid dispensing system of FIGS. 1-3;

FIG. 5 is a schematic view of the gauge panel subsystem for the cryogenic fluid dispensing system of FIG. 4;

FIGS. 6a-6m illustrate the operation of the cryogenic fluid dispensing system of FIG. 4;

FIG. 7 is a schematic view of a second embodiment of the cryogenic fluid dispensing system of the present invention;

FIGS. 8a-8k illustrate the operation of the cryogenic fluid dispensing system of FIG. 7; and

FIGS. 9a-9j illustrate the method of operating the cryogenic fluid dispensing system of FIGS. 7 and 8a-8k.

### DESCRIPTION OF THE PREFERRED EMBODIMENTS

A first embodiment of the system of the present invention is indicated in general at 10 in FIGS. 1-3. The system features a jacketed bulk tank 12 and pulse tank or sump 14. Low pressure bulk tank 12 preferably has a volume of approximately 1000 gallons while sump 14 preferably has a volume of approximately 300 liters. Such a capacity will permit the system to fill both one and multiple cylinders at a use point without refilling the sump. A bulk tank size of 2000 gallons with a sump volume of 500 liters are preferred if larger delivery amounts are contemplated.

While the bulk tank 12 is low pressure, sump 14 preferably has a maximum allowable working pressure of approximately 500 psi. The delivery pressure of the system will typically be approximately 50 psi above the pressure of the receiving vessel. As a result, the system can dispense liquid to a 400 psi container such as those used for laser welding.

The bulk tank 12 and sump 14 are mounted on a frame 16. Frame 16 preferably is mounted upon a transport truck, trailer or some other type of vehicle so that the system is mobile and may be transported to a use point such as a plant, hospital or laboratory. As will be explained in greater detail below, a pair of finned, pressure building heat exchangers 22a and 22b are attached to the sump as is a dispensing hose 24. While two heat exchangers are illustrated, it is to be understood that an alternative number (one or more than two) of heat exchangers may be used.

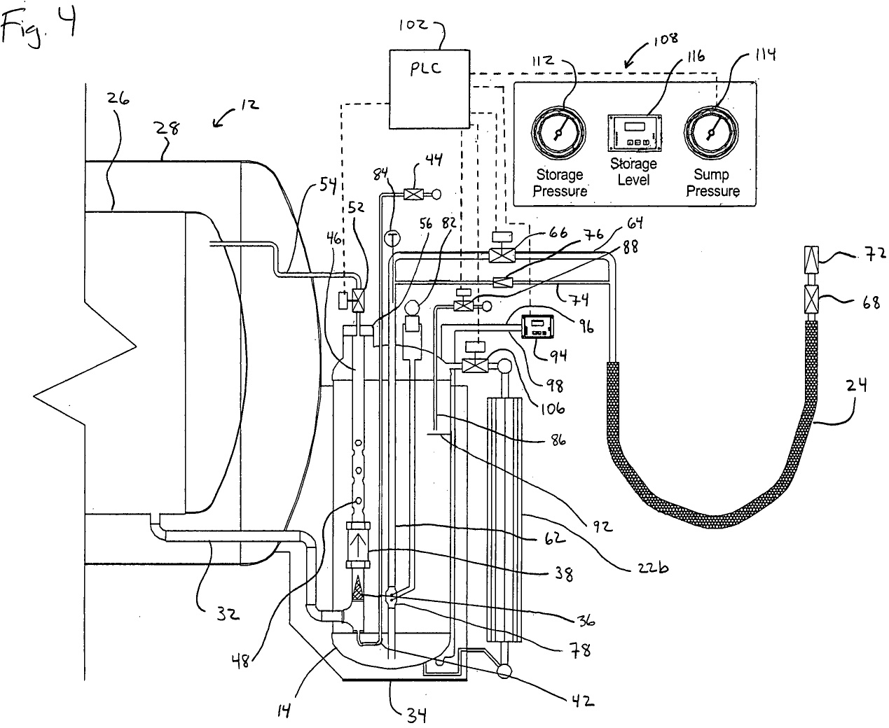

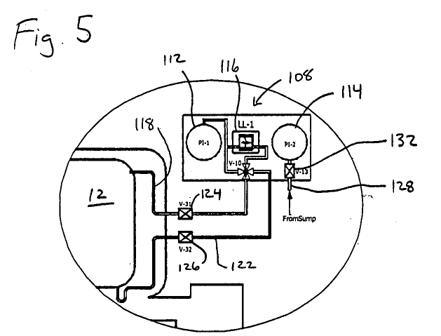

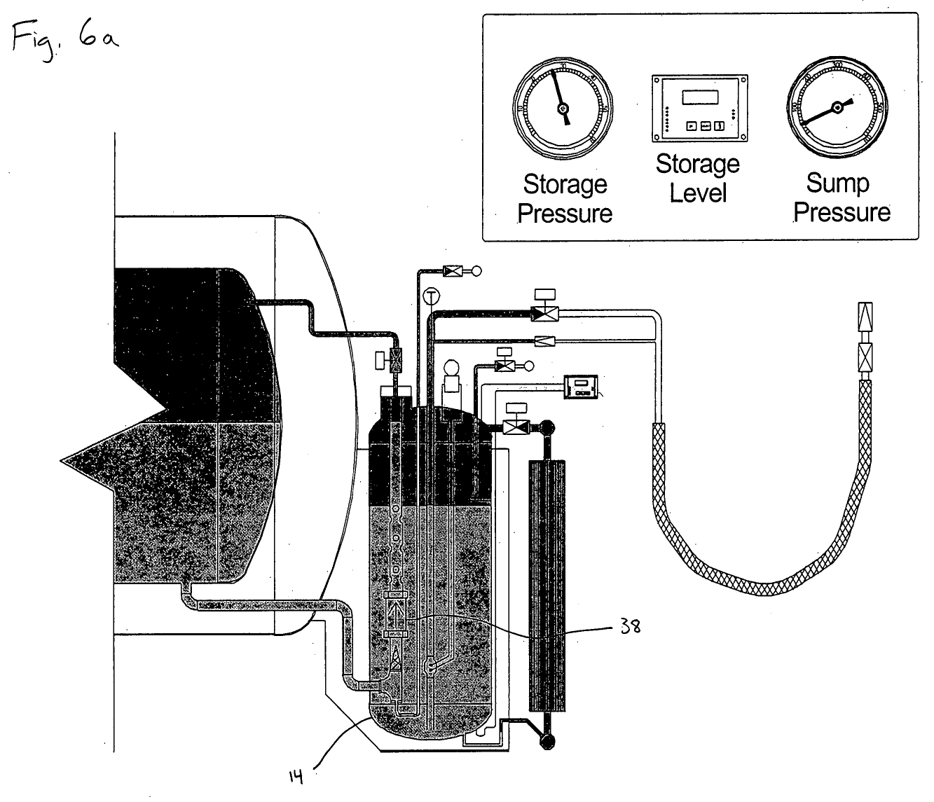

As illustrated in FIG. 4, low pressure bulk tank 10 includes an inner vessel 26 surrounded by an outer jacket 28 in a vacuum-insulated fashion. The inner vessel and outer jacket may have outer diameters, for example, of 60″ and 80″, respectively. A sump supply line 32 feeds liquid cryogen by gravity from the inner vessel of the bulk tank to the sump 14. Sump 14 is partially insulated by vacuum-insulation jacket 34. Sump supply line 32 is insulated by bulk tank jacket 28 and sump jacket 34.

Liquid cryogen flowing through sump supply line 32 encounters a mesh “witches cap” strainer 36 and then a supply check valve 38. While the supply valve 38 is illustrated as a check valve, alternative types of valves, including automated valves and manually operated valves, may be used instead. The strainer 36 limits the deposit of debris on the seat of the check valve 38. Check valve 38 permits liquid to only flow from the bulk tank to the sump.

A sample line 42 serves multiple functions and features a lower end in communication with the outlet of the sump supply line 32 and the inlets of the strainer 36 and check valve 38 and an upper end equipped with a valve 44. Valve 44 may be manually opened to permit the removal of samples of cryogenic liquid through line 42 as well as debris trapped by strainer 36. In addition, gas may be introduced into the inlets of strainer 36 and check valve 38 via line 42 to unseat check valve 38 should it become stuck in the closed configuration.

The outlet of the check valve 38 communicates with the bottom end of a pipe 46 which features a number of apertures 48. Cryogenic liquid flowing through the check valve from the bulk tank enters the sump through these apertures. The top end of pipe 46 communicates via automated vent valve 52 with a vent return line 54 that leads to the head space of the inner vessel 26 of bulk tank 12. The top end of pipe 46 also encounters a bolted knuckle 56 formed in the top of the sump 14 that permits removal of the check valve 38 for replacement or servicing.

A dip tube 62 features a bottom end positioned near the bottom of sump 14 and an upper end that communicates with a generally horizontal portion 64. Generally horizontal portion 64 is equipped with automated dispensing valve 66 and communicates with the system dispensing hose 24. Dispensing hose 24 is provided with nozzle dispensing and check valves 68 and 72, respectively. A hose drain line 74 is configured in parallel with automated dispensing valve 66 and features drain check valve 76.

Dip tube 62 is equipped near its lower end with a cryogenic meter 78. Cryogenic meter 78 communicates via wires with meter transmitter 82. A resistance temperature device 84 is positioned within the upper portion of the dip tube so as to be in the flow stream of cryogenic liquid moving there through during dispensing. During dispensing, a microprocessor (not shown) receives a signal proportional to the flow rate through meter 78 via meter transmitter 82. The microprocessor also receives the temperature of the cryogen flowing through the meter via resistance temperature device 84. As explained in commonly assigned U.S. Pat. No. 5,616,838 to Preston et al., the density of the liquid cryogen flowing through the meter may be calculated by the microprocessor using the temperature data so that the amount of cryogenic liquid delivered to the use device may be accurately determined/metered based upon the flow rate from the meter 78 and the density calculation. The positioning of the meter 78 near the bottom of the sump generally keeps it submerged in, and thus cooled by, cryogenic liquid so that no meter cool down period is necessary prior to dispensing.

A sump vent line 86 is equipped with an automated sump vent valve 88 and communicates with the upper portion of the sump. A plate-like splash guard 92 is positioned beneath the vent line 86 and limits entrainment during filling of the sump.

The liquid level within the sump is determined using a sensor 94 that is preferably a differential pressure gauge. An appropriate gauge and method are described in commonly assigned U.S. Pat. No. 6,542,848 and U.S. Pat. No. 6,782,339, both to Neeser et al. Such a gauge determines the liquid level within the sump by taking pressure measurements from the top and bottom of the sump via lines 96 and 98. As will be explained in greater detail below, sensor 94 communicates the liquid level within the sump 14 to a controller 102 which controls the automated valves of the system.

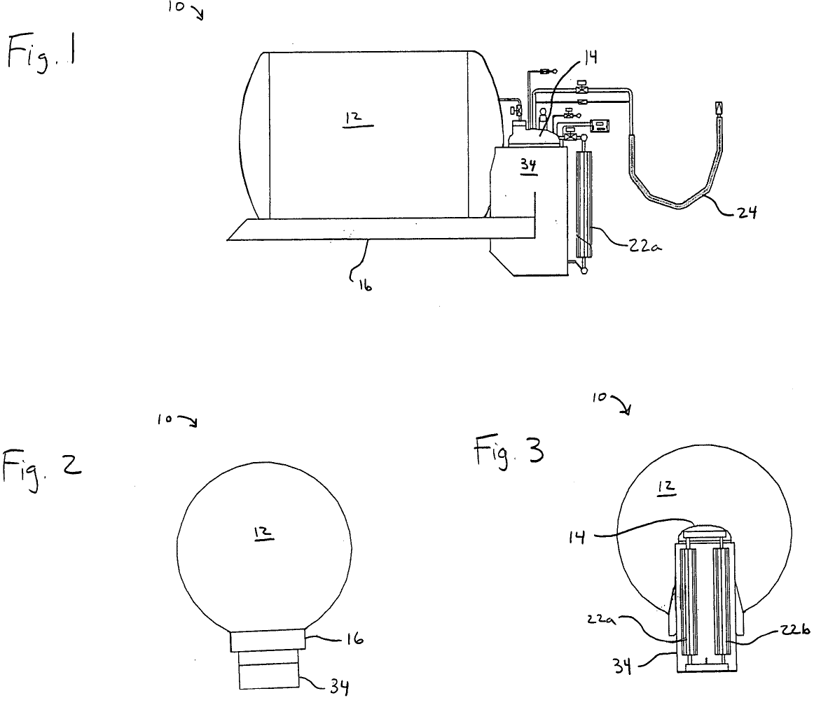

A pair of pressure building heat exchangers 22a and 22b (FIGS. 3 and 4) receive liquid cryogen from the bottom of the sump when automated pressure building valve 106 (FIG. 4) is open. The liquid is vaporized within the heat exchangers via ambient temperature and provided to the headspace of the sump so as to build pressure therein. This will be explained in greater detail below along with the overall operation of the system.

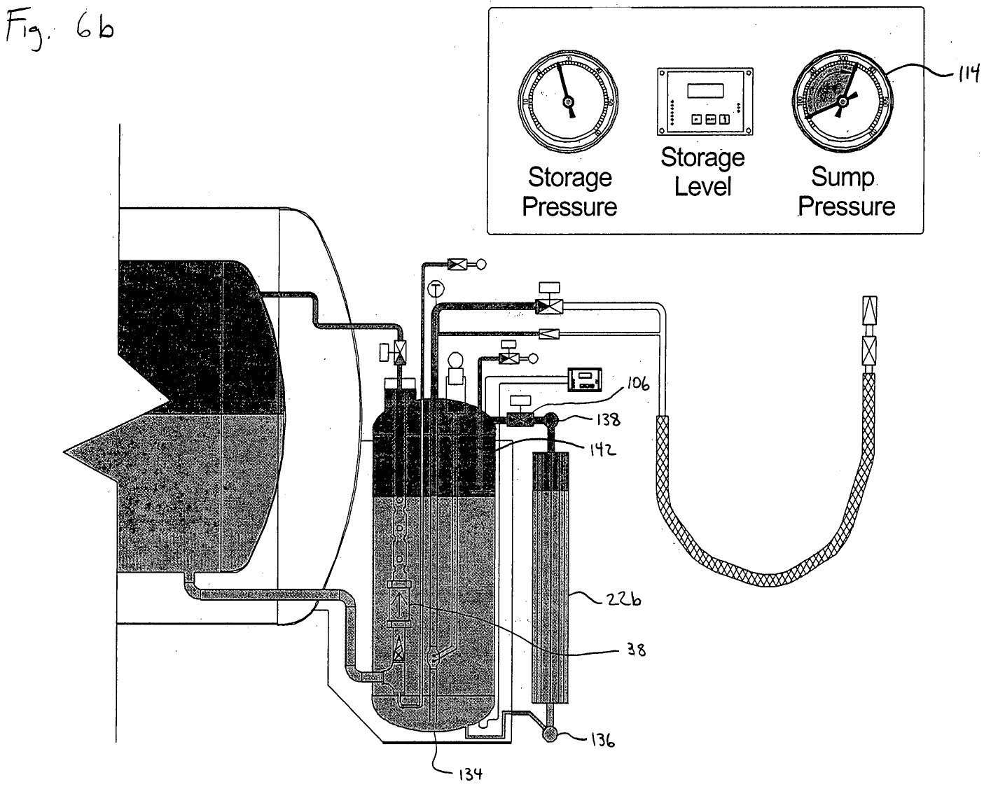

The system is provided with a gauge panel, indicated in general at 108 in FIGS. 4 and 5. The gauge panel includes a storage pressure gauge 112 indicating the pressure in the bulk tank 12 and a sump pressure gauge 114 indicating the pressure in the sump 14. The gauge panel also includes a gauge 116 showing the liquid level in the bulk tank 12.

The subsystem whereby the gauge panel 108 receives data from the bulk tank is illustrated in FIG. 5. Bulk tank liquid level gauge 116 is actually a differential pressure gauge similar to the differential pressure gauge 94 in FIG. 4 used to determine the liquid level in the sump and described in the commonly assigned Neeser et al. '848 and '339 patents. As a result, the gauge 116 receives the pressure from the top and bottom of the bulk tank via lines 118 and 122 and valves 124 and 126 and uses this pressure data to determine the liquid level in the bulk tank. From this data, the pressure in the bulk tank may also be determined by bulk tank pressure gauge 112. Sump pressure gauge 114 determines the pressure within the sump via a pressure connection with the head space of the sump via line 128 and valve 132.

The electronic sequencer or programmable logic controller 102 of FIG. 4 allows push-button delivery of cryogenic liquid without manipulation of the valves by the operator. This allows for reduced operator training time and fast deliveries. Controller 102 may optionally provide invoice printouts and data transfer capability.

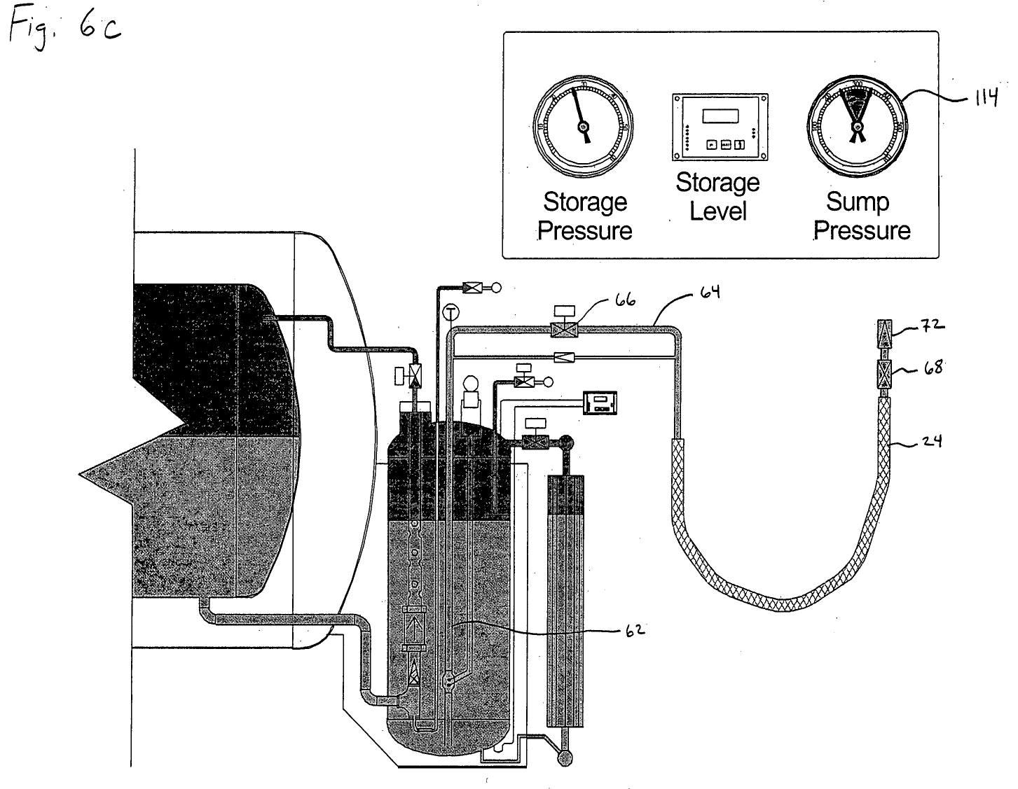

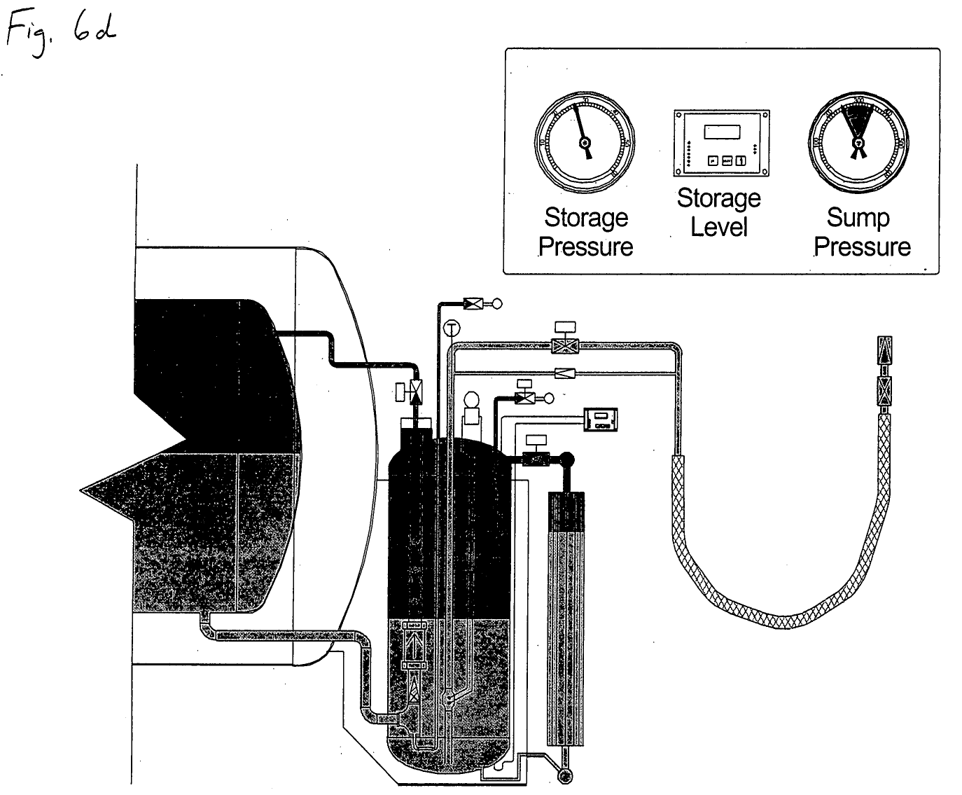

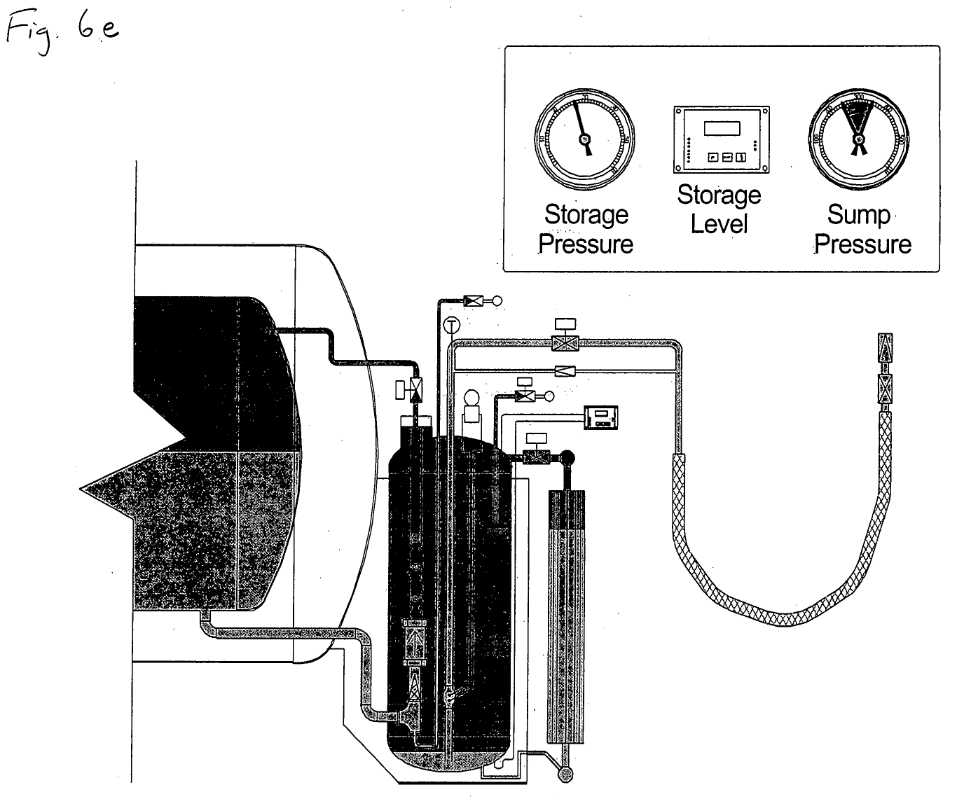

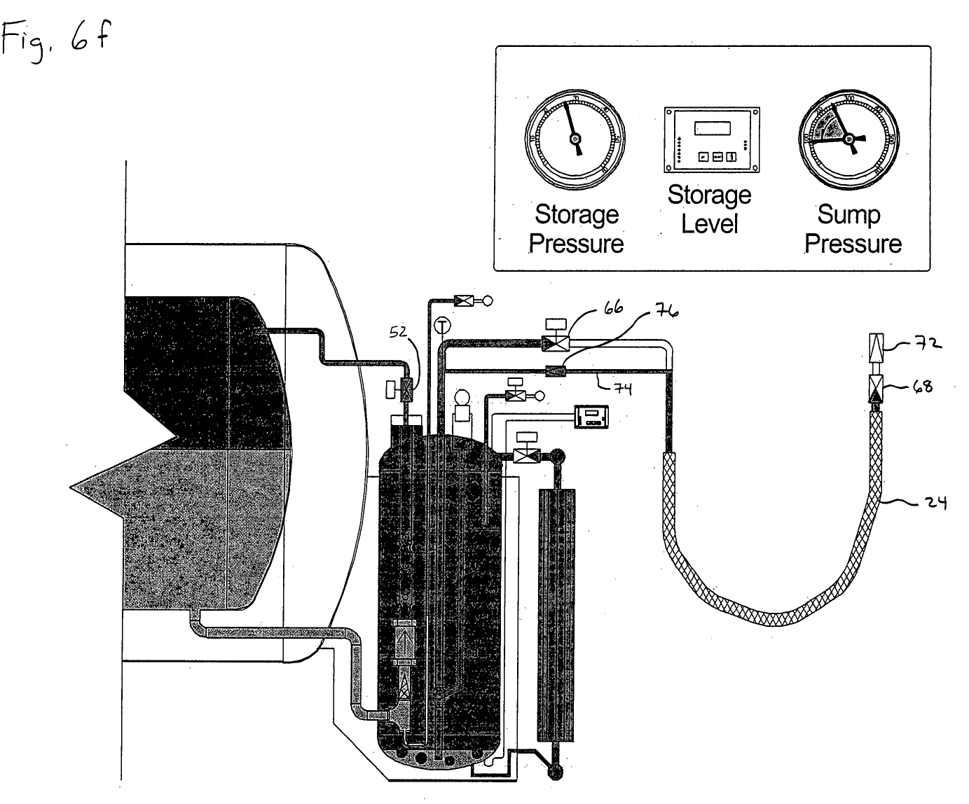

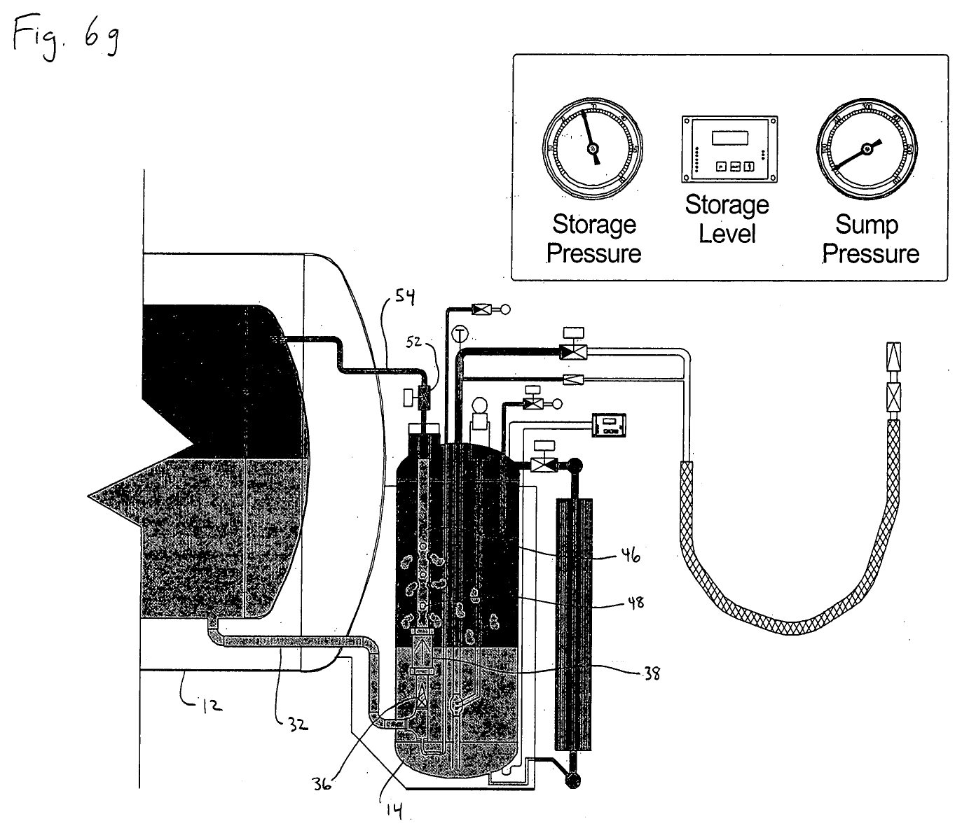

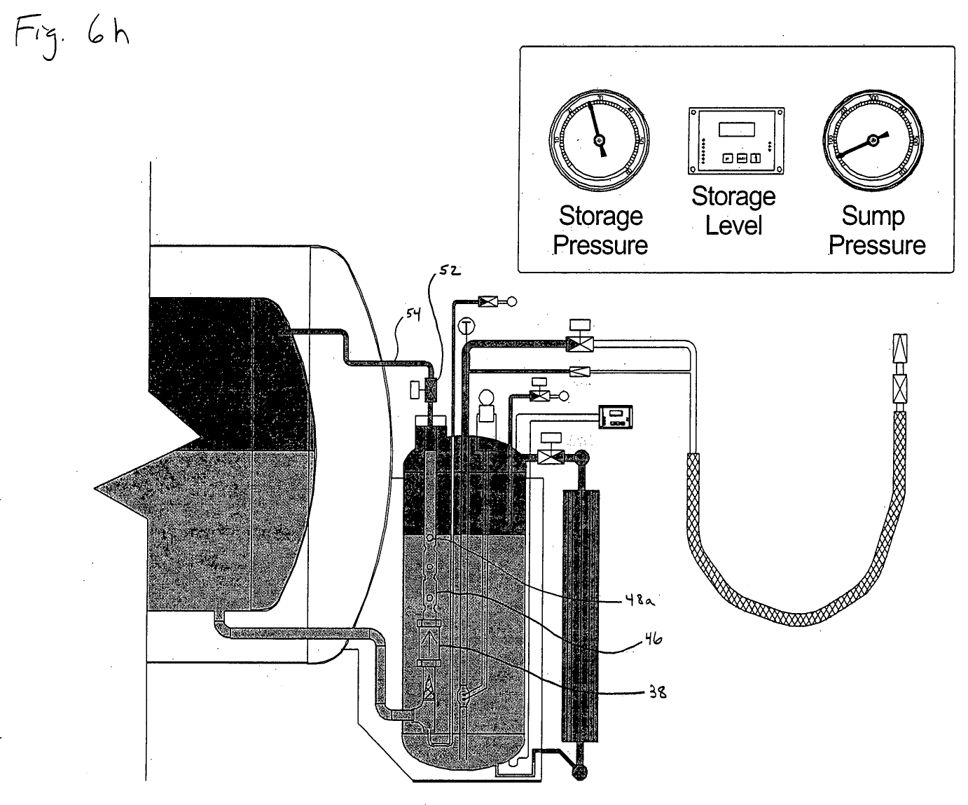

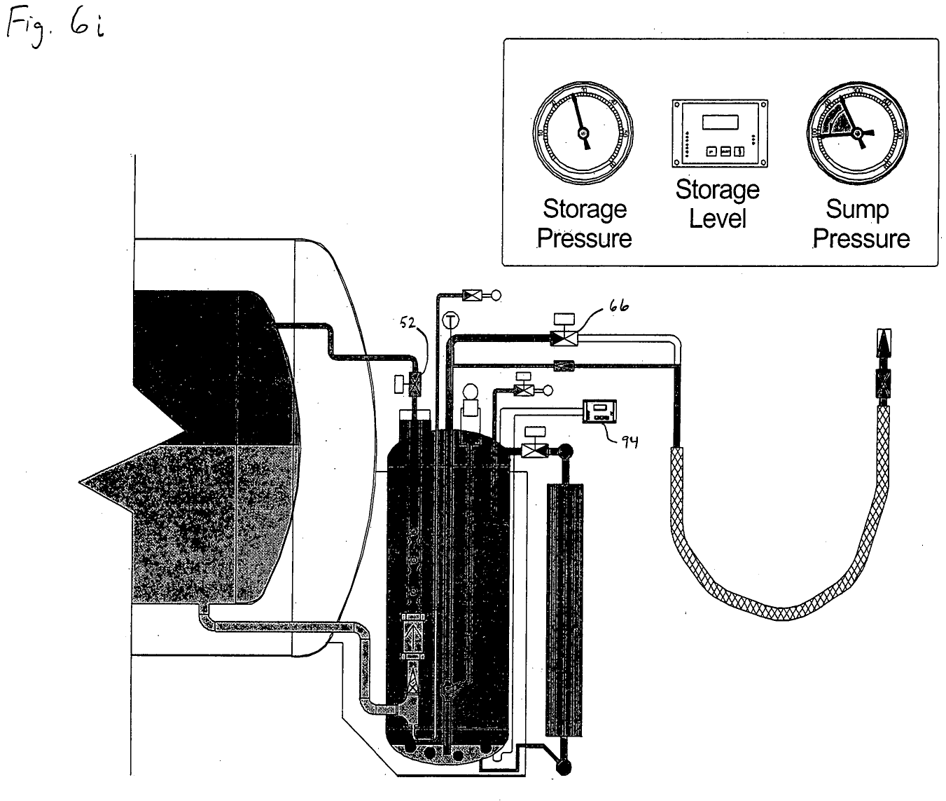

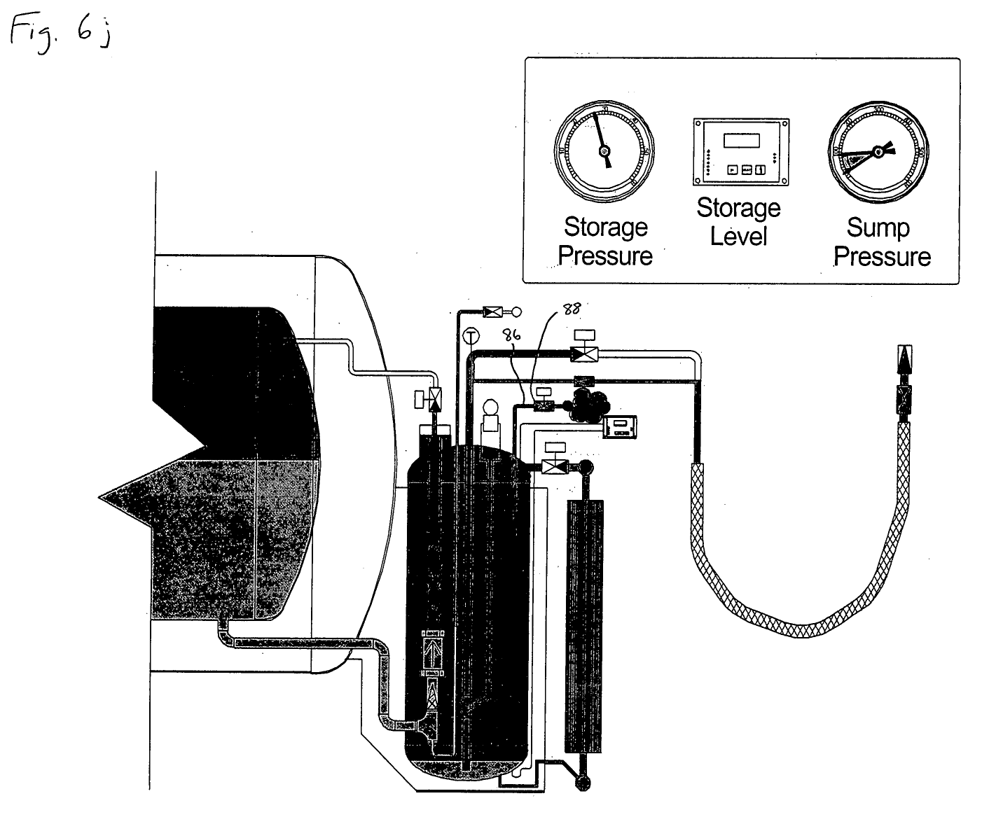

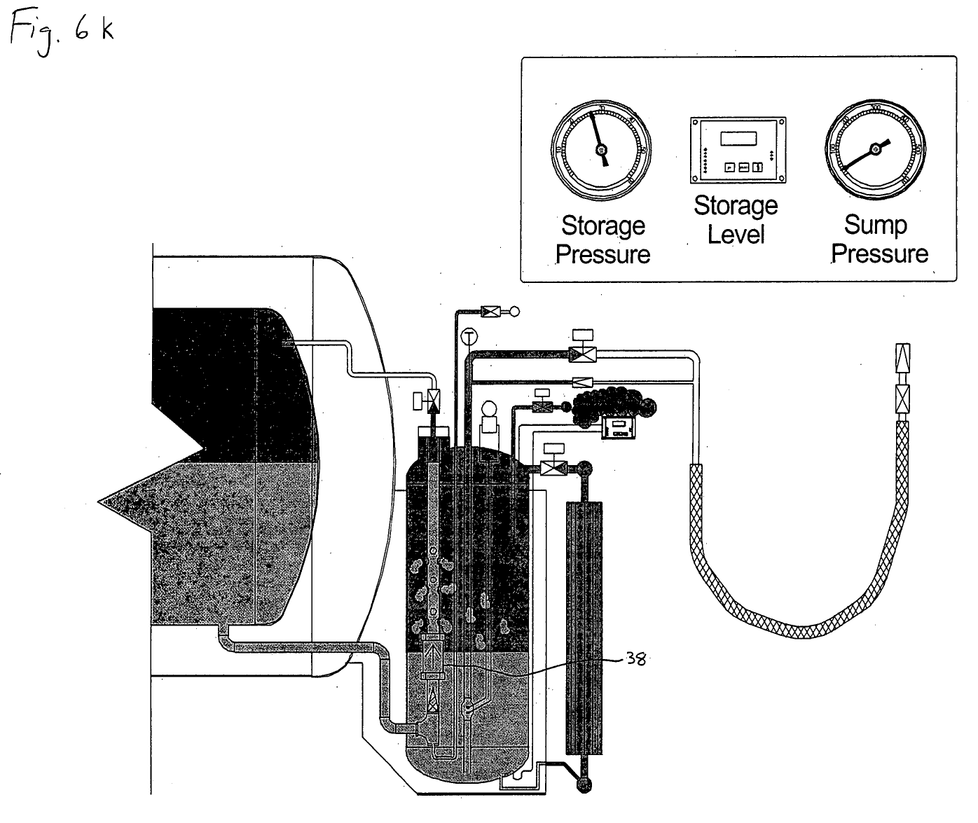

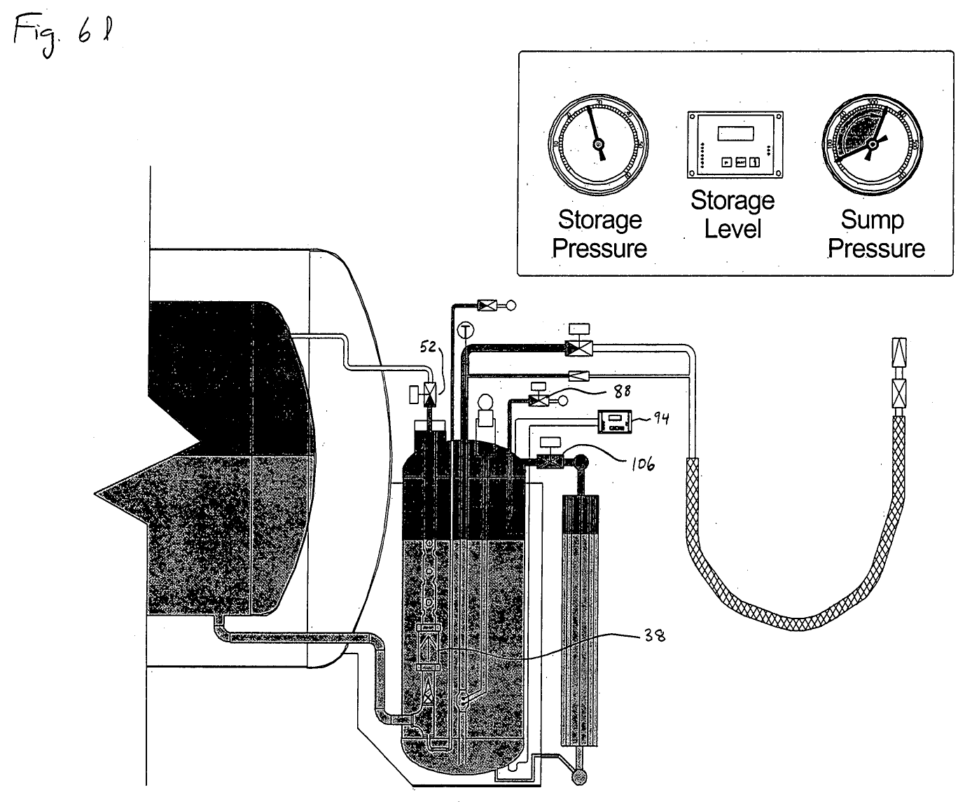

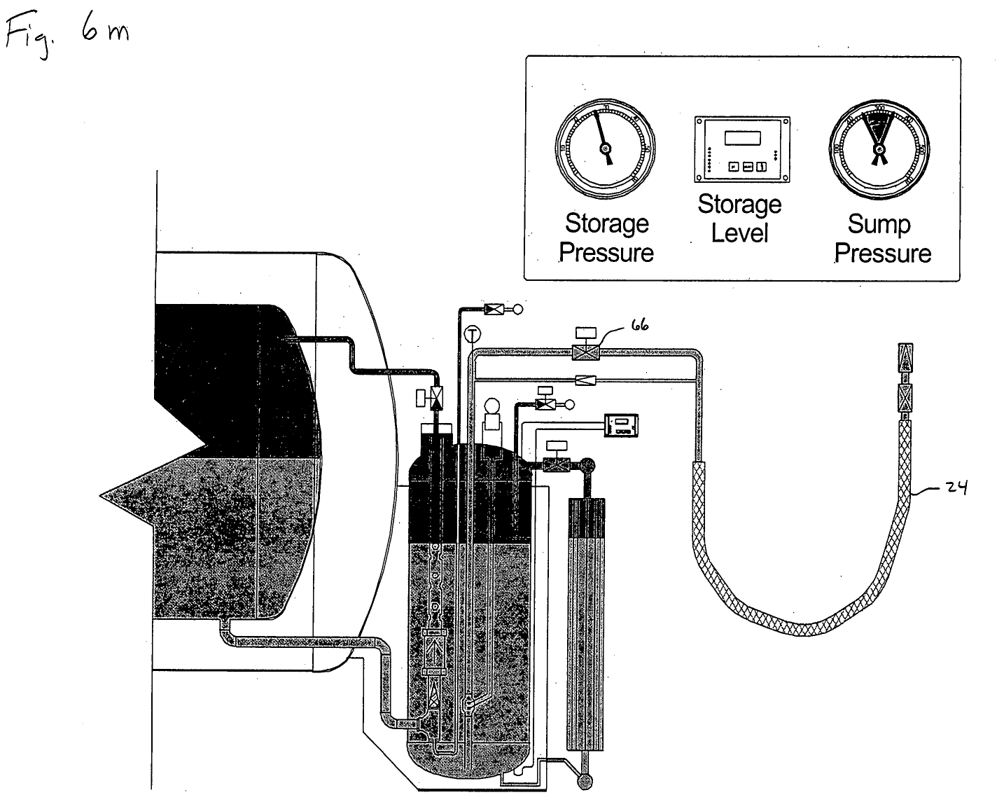

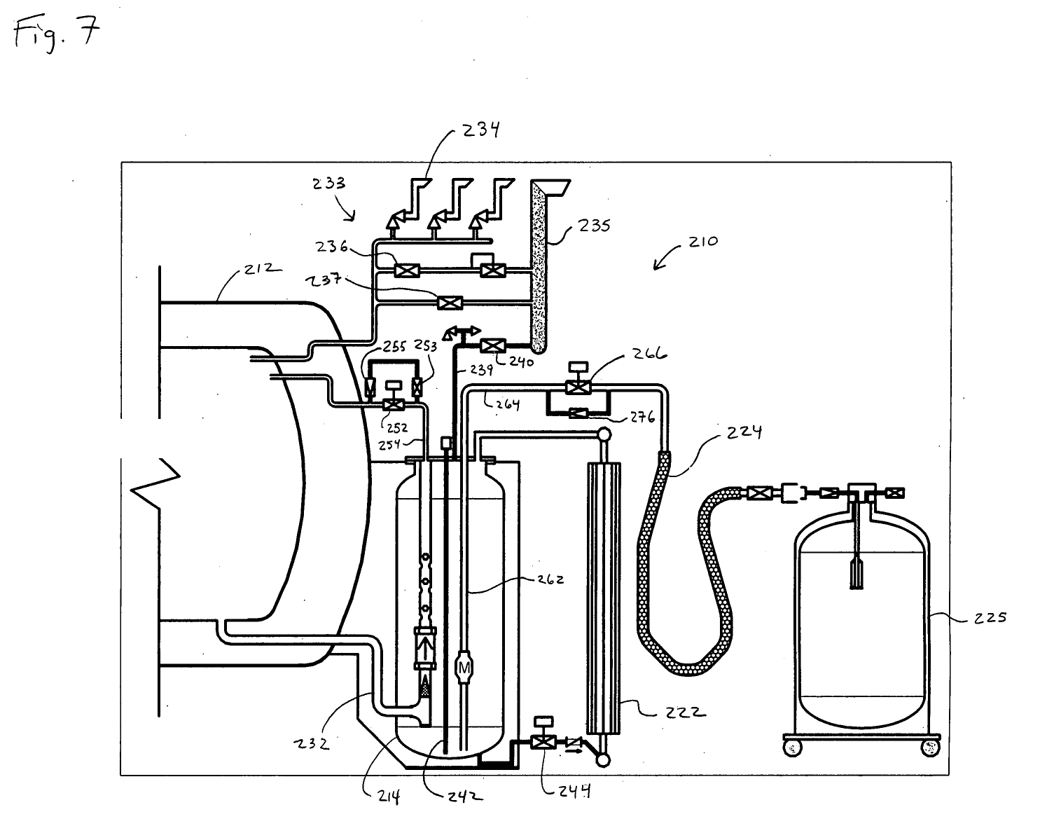

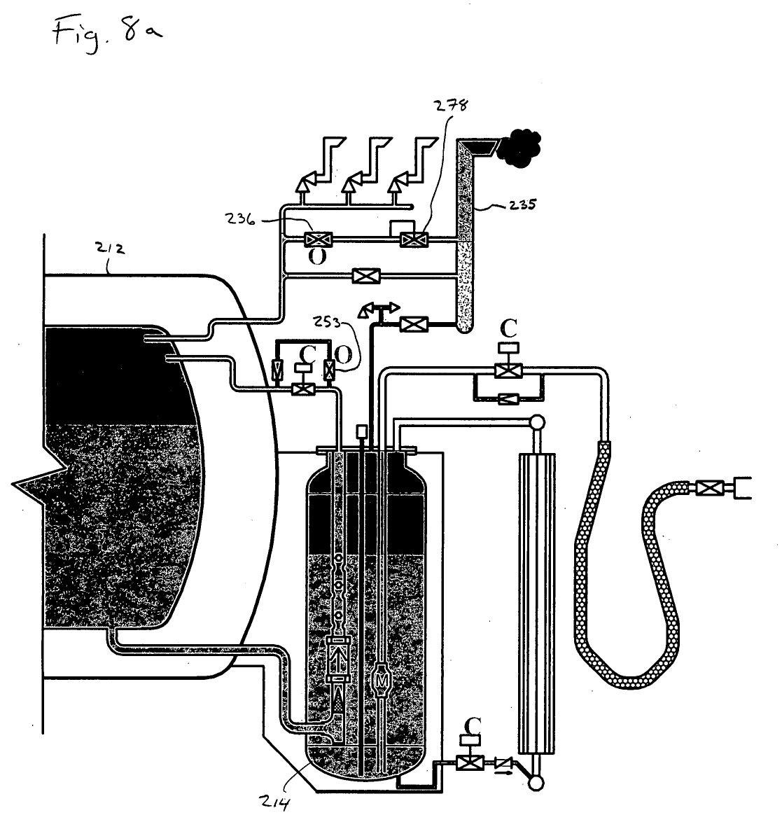

The operation of the system of FIG. 4 will now be explained with reference to FIGS. 6a through 6m. The light shading in FIGS. 6a through 6m represents cryogenic liquid while the dark shading represents cryogenic vapor. Typically upon arrival at a use point, where refilling of customer cylinders or tanks is to take place, the sump 14 will be filled to capacity with approximately 300 liters of cryogenic liquid. The pressure in the sump at this point is approximately 27 psi, which is the pressure within the bulk tank, and the check valve 38 is open.

The operator then presses a button on the system controller (102 in FIG. 4) so as to initiate pressure building and dispensing. As illustrated in FIG. 6b, pressing the button causes the controller to open automated pressure building valve 106 so that cryogen from the liquid side 134 of the sump enters the inlet 136 of pressure building heat exchangers 22a (FIG. 3) and 22b and is vaporized therein by ambient heat. The resulting vapor travels through the outlet 138 of the heat exchanger 22b to the head space 142 of the sump. As a result, the pressure within the sump is raised to the dispensing or delivery pressure of 350 psi. When the pressure first begins to build in the sump, check valve 38 closes automatically.

As illustrated in FIG. 6c, when the pressure in the sump reaches the delivery pressure of 350 psi, the controller, which communicates with the sump pressure gauge 114, automatically opens automatic dispensing valve 66 so that liquid is dispensed from the sump through dip tube 62, horizontal portion 64, dispensing hose 24 and open nozzle dispensing and check valves 68 and 72. A delivery pressure of 350 psi permits cryogenic liquid to be dispensed or delivered at a rate of 20 gpm so that quick filling of the customer liquid cylinders or tanks may occur.

As the cryogenic liquid delivery or dispensing occurs, as illustrated in FIGS. 6d and 6e, the liquid level in the sump will drop, as will the sump pressure. When the tank or cylinder receiving the liquid cryogen is full, the fill is terminated manually by the operator or automatically by a float-type shut off device in the receiving cylinder or tank. Such a float-type device is illustrated in commonly assigned U.S. Pat. No. 5,787,942 to Preston et al. In either instance, the controller closes the automated dispensing valve 66, as illustrated in FIG. 6f. If the delivery for the use point requires less than 300 liters of cryogenic liquid, the dispensing at the current use point is complete.

The nozzle dispensing and check valves 68 and 72 are closed when the operator disconnects the dispensing hose 24 from the liquid cylinder or tank being filled at the use point. As illustrated in FIG. 6f, liquid and vapor trapped in the dispensing hose then drains into the sump through hose drain line 74 and drain check valve 76. This prevents pressure from building within the dispensing hose between deliveries.

When the liquid level within the sump drops to a predetermined level, as illustrated in FIG. 6f, the controller automatically opens vent valve 52. Furthermore, as illustrated in FIG. 6g, when the pressure within the sump drops below the bulk tank pressure of approximately 27 psi, check valve 38 opens. As a result, as described above, cryogenic liquid flows from the bulk tank 12 via gravity into the sump 14 through the sump supply line 32, strainer 36, check valve 38 and apertures 48 of pipe 46. As the sump is refilled with cryogenic liquid, vapor displaced from the sump travels into pipe 46 through the apertures 48 and is directed back to the bulk tank via vent valve 52 and vent return line 54.

It should be noted that when the system is configured for traveling between delivery or use points, cabinet doors (not shown), which cover a compartment within which the dispensing hose is stored, are closed. The controller senses the closed doors and automatically opens vent valve 52.

When the liquid level in the sump covers the top-most aperture 48a of the pipe 46, as illustrated in FIG. 6h, the vapor in the sump that would be displaced by the entering liquid can no longer escape through the vent valve 52 and vent return line 54. As a result, the transfer of liquid to the sump from the bulk tank is halted. The pressure within the sump stabilizes at the same pressure as the bulk tank, that is, approximately 27 psi. The check valve 38 remains open until the initiation of pressure building, as described above with respect to FIG. 6b.

FIGS. 6f through 6h illustrate the situation where the total amount of cryogenic liquid delivered at a use point is less than 300 liters. FIGS. 6i through 6m illustrate the situation where the sump has been nearly emptied of cryogenic liquid and additional dispensing needs to take place at the current use point.

As illustrated in FIG. 6i, when the liquid within the sump drops to a predetermined level, as detected by differential pressure gauge 94, the controller interrupts the fill by automatically closing the dispensing valve 66 and opening valve 52 in vent return line 54. In addition, as illustrated in FIG. 6j, sump vent valve 88 is automatically opened so that the sump vents vapor to the atmosphere through sump vent line 86. As explained previously and illustrated in FIG. 6k, check valve 38 opens automatically when the pressure within the sump drops below the pressure of the bulk tank, that is, approximately 27 psi. Previously venting the sump tank to atmospheric pressure permits the refill of the sump to occur at an accelerated rate. As a result, the sump refills at a rate of approximately 40 gpm.

With reference to FIG. 61, when the sump reaches its full level the controller senses that the sump is full via differential pressure gauge 94 and closes vent valves 52 and 88 and opens pressure building valve 106 so that pressure building occurs via the pressure building heat exchangers as described previously. Check valve 38 closes due to the pressure building and the pressure within the sump rises to the delivery pressure of 350 psi. When the delivery pressure is reached, as illustrated in FIG. 6m, the controller automatically opens dispensing valve 66 and dispensing resumes via dispensing hose 24.

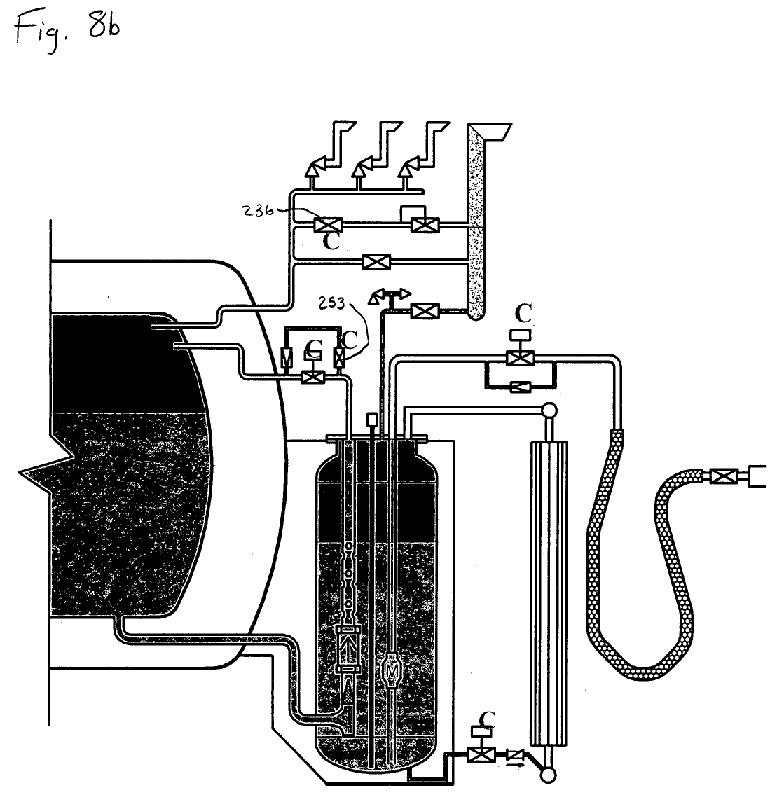

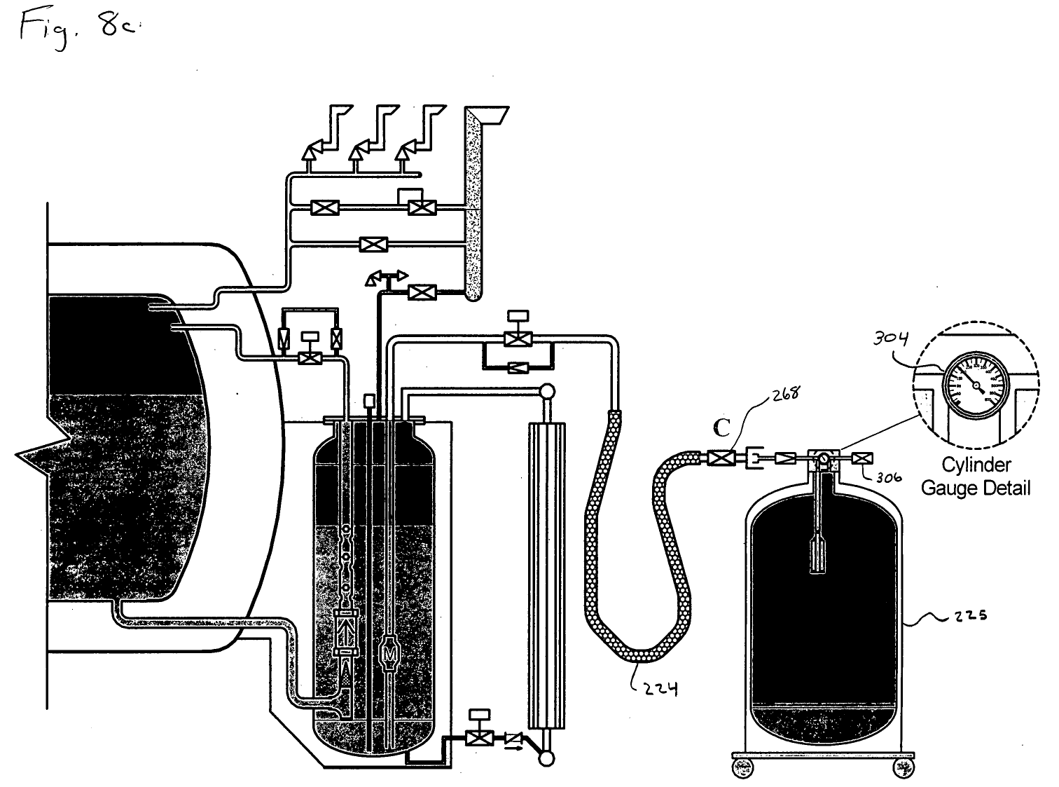

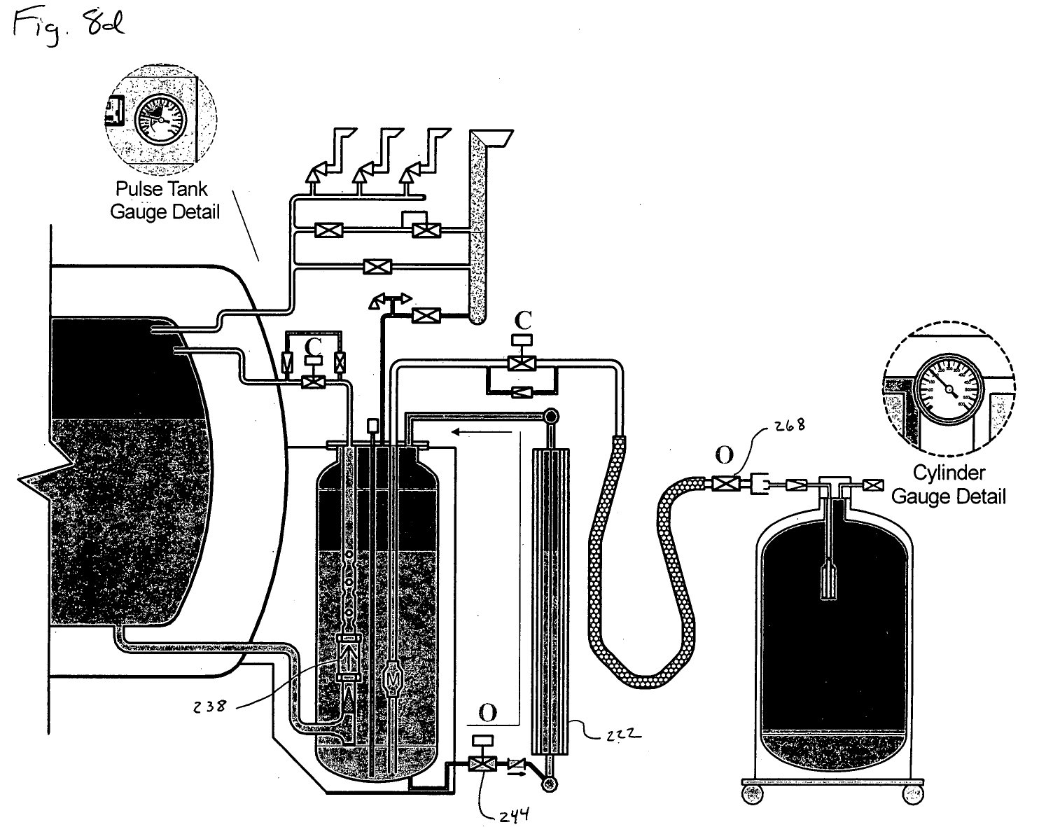

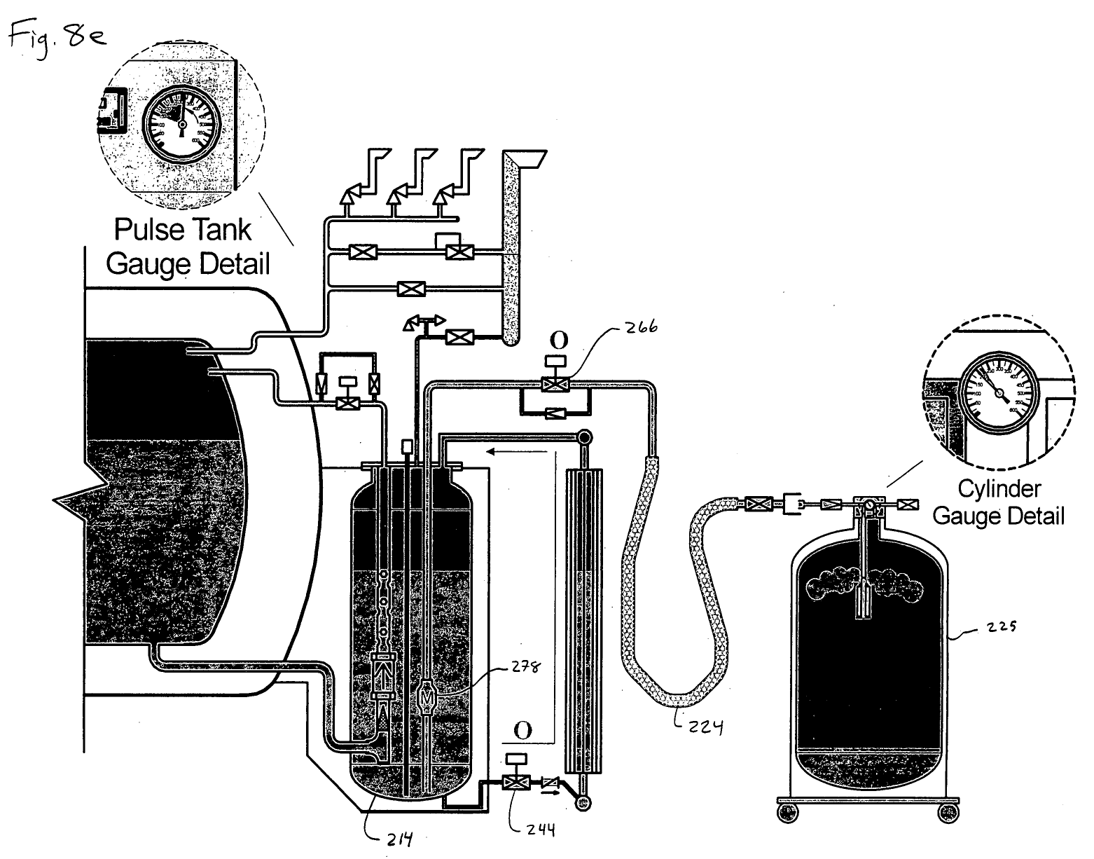

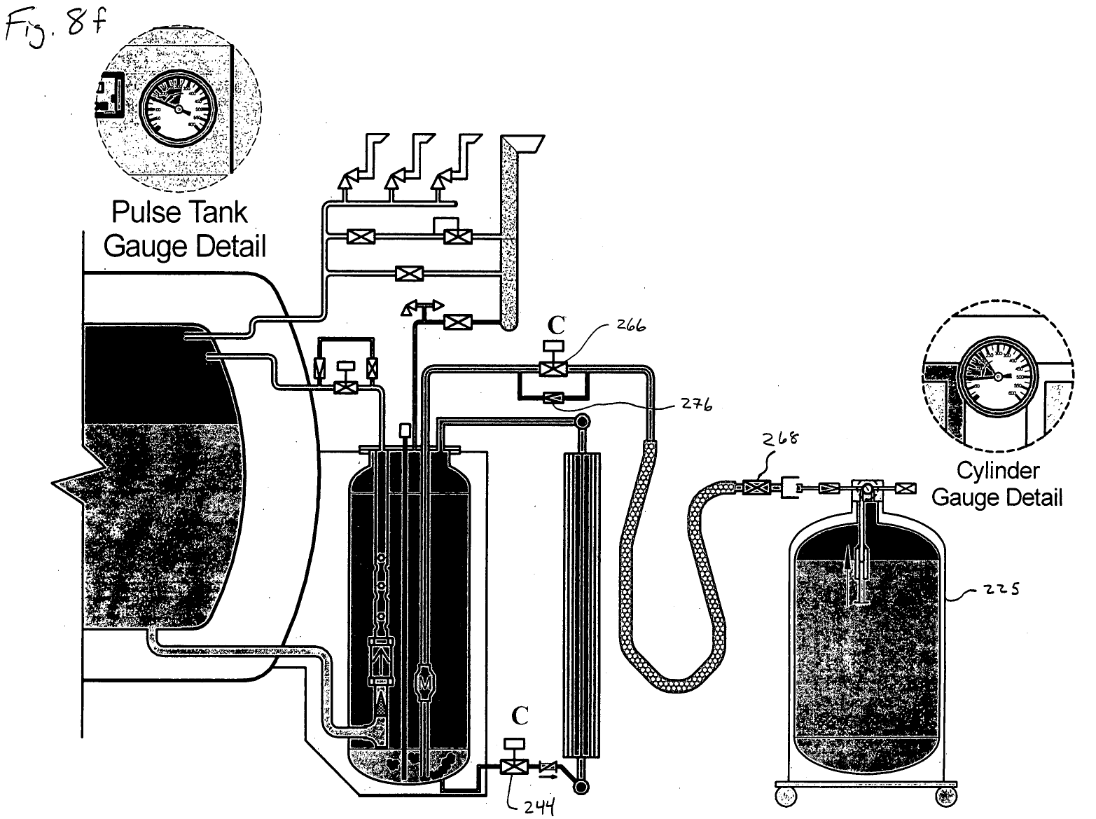

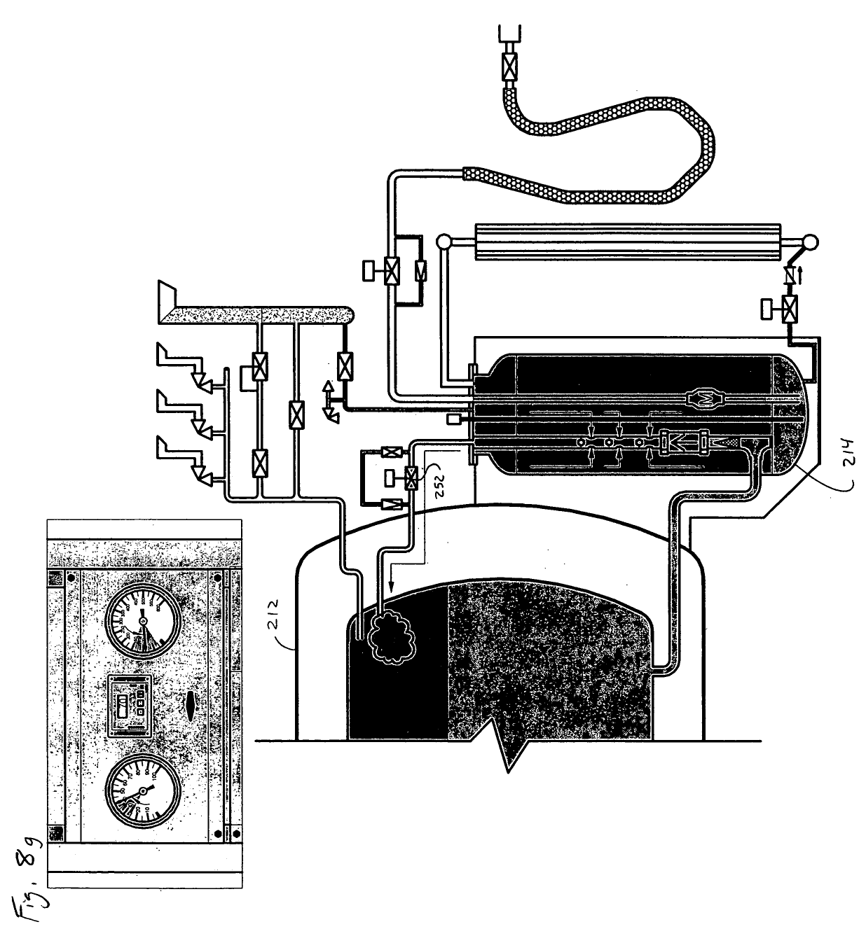

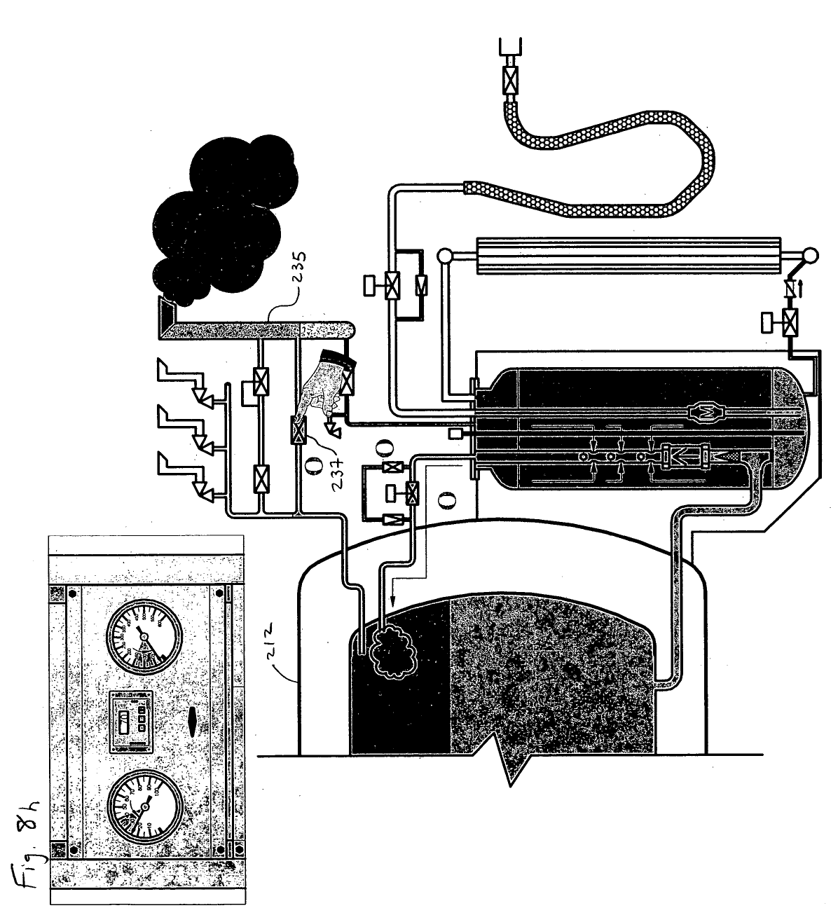

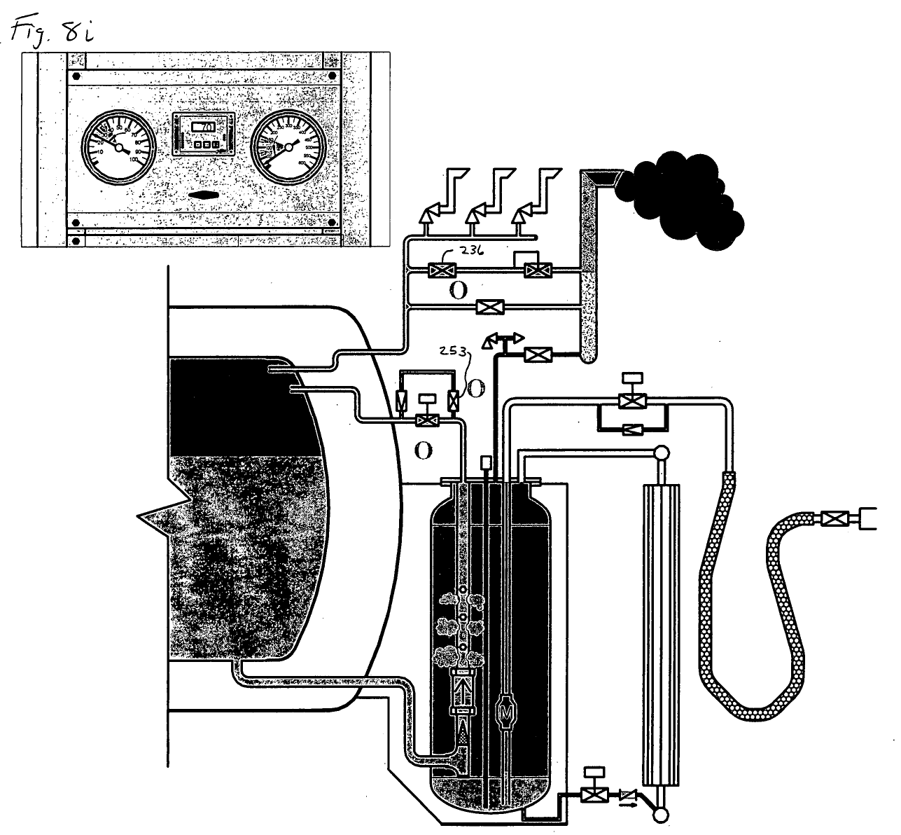

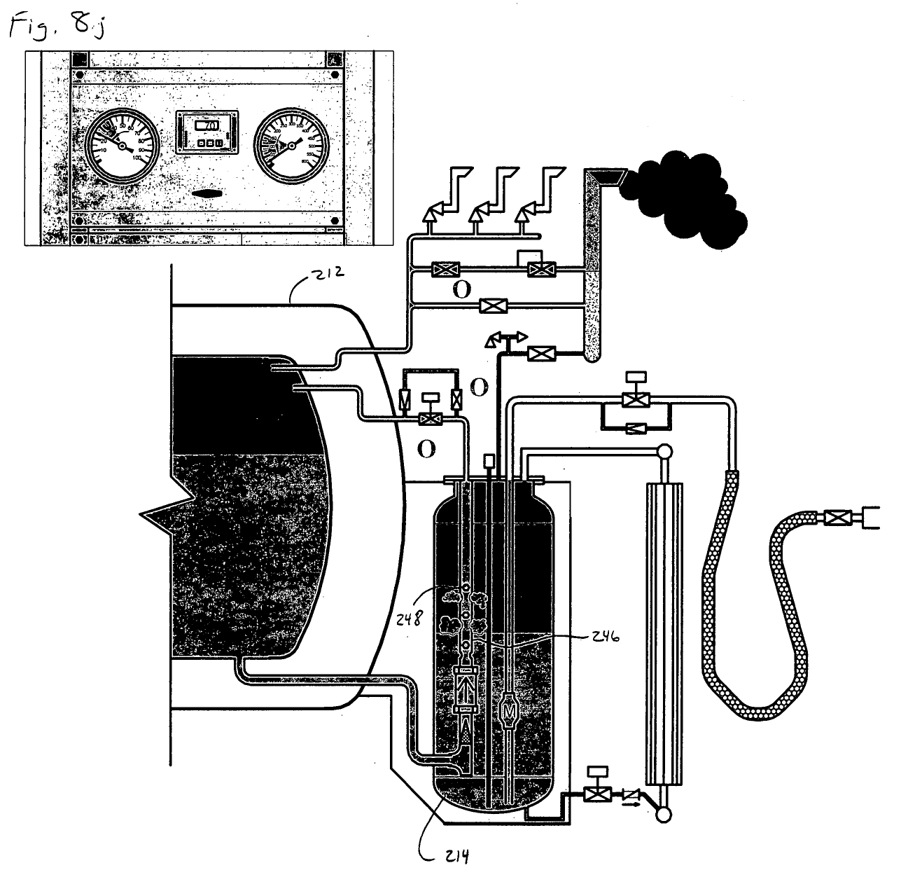

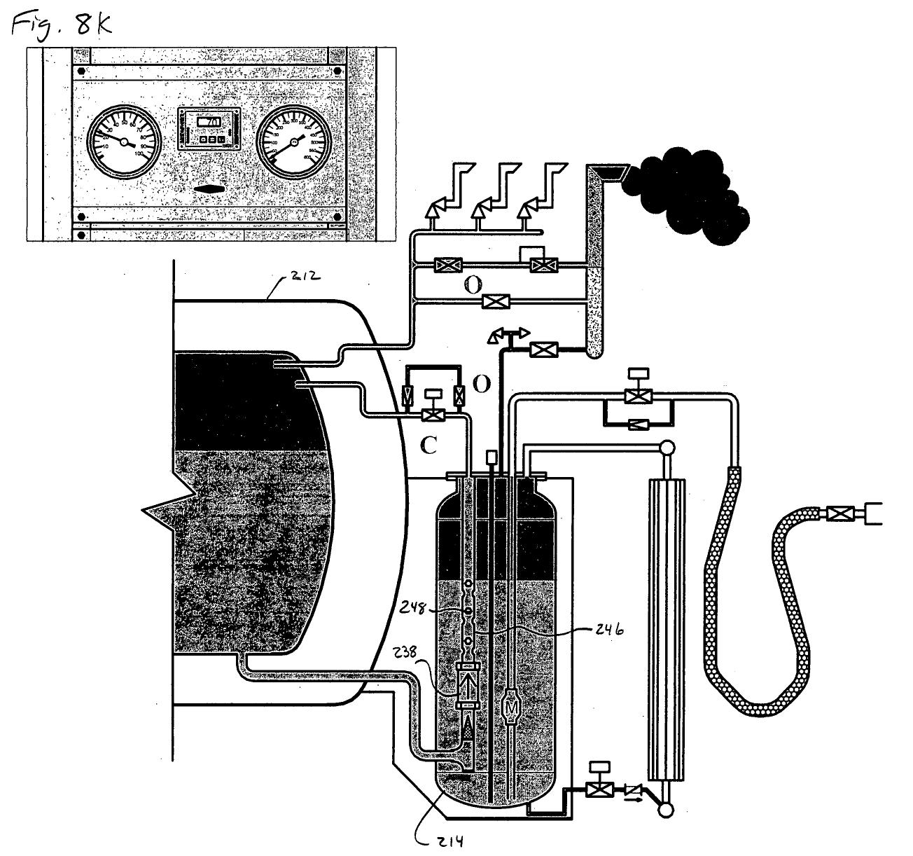

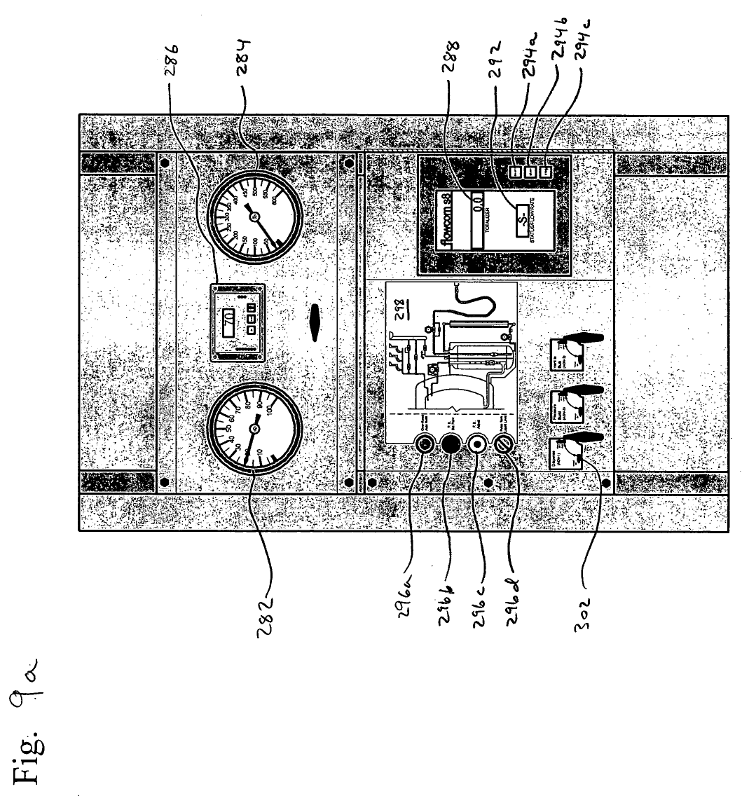

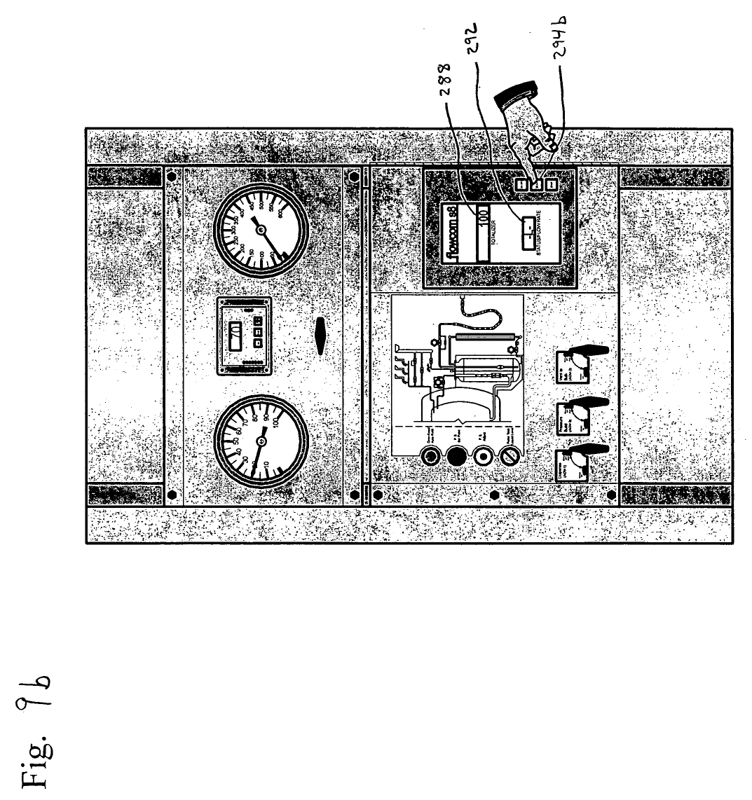

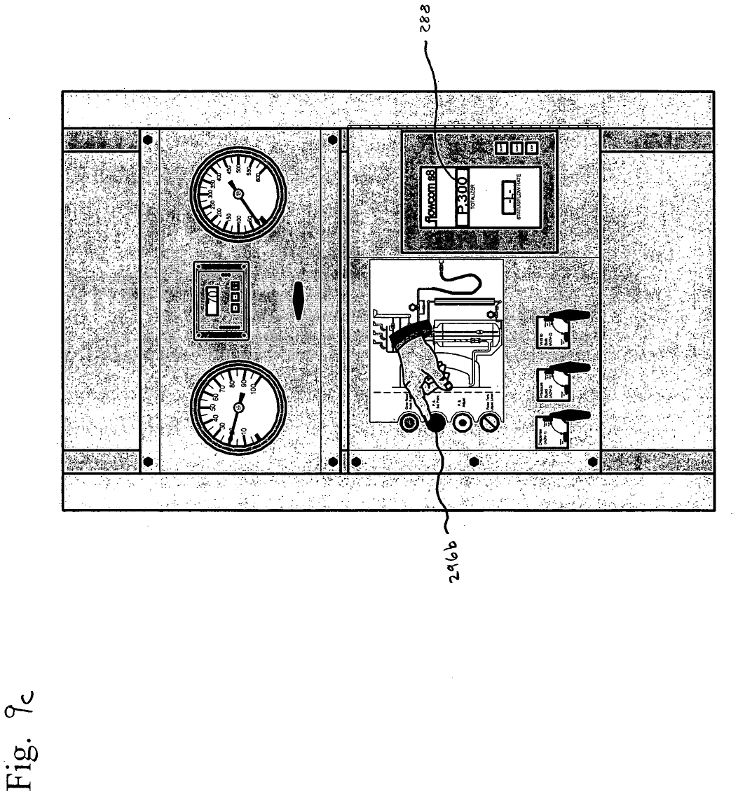

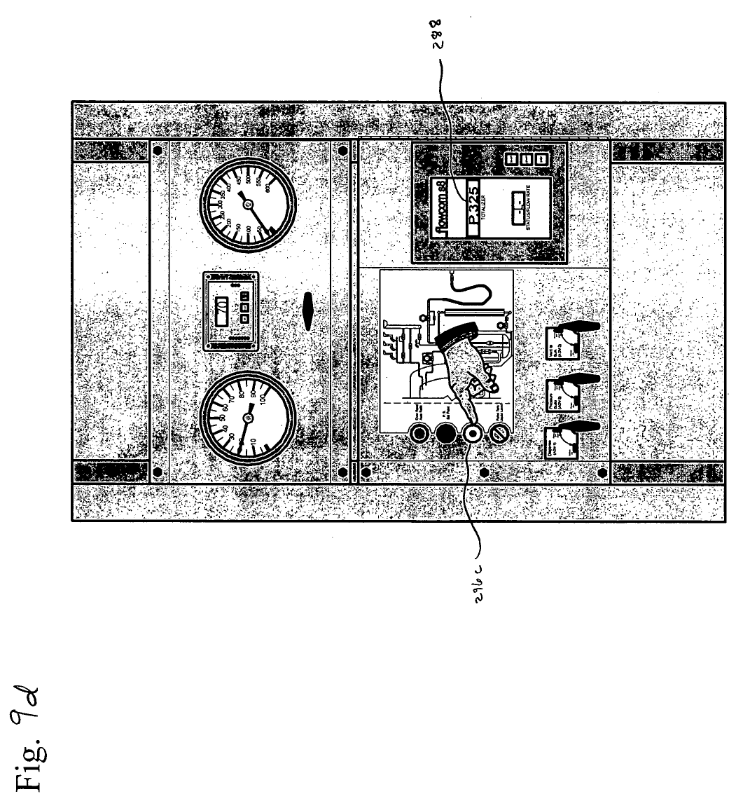

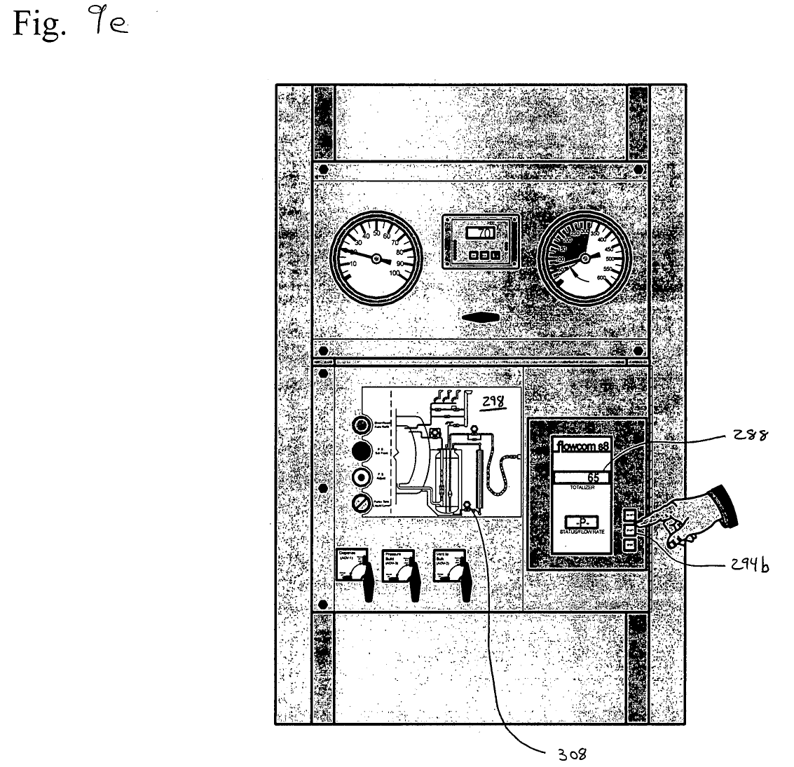

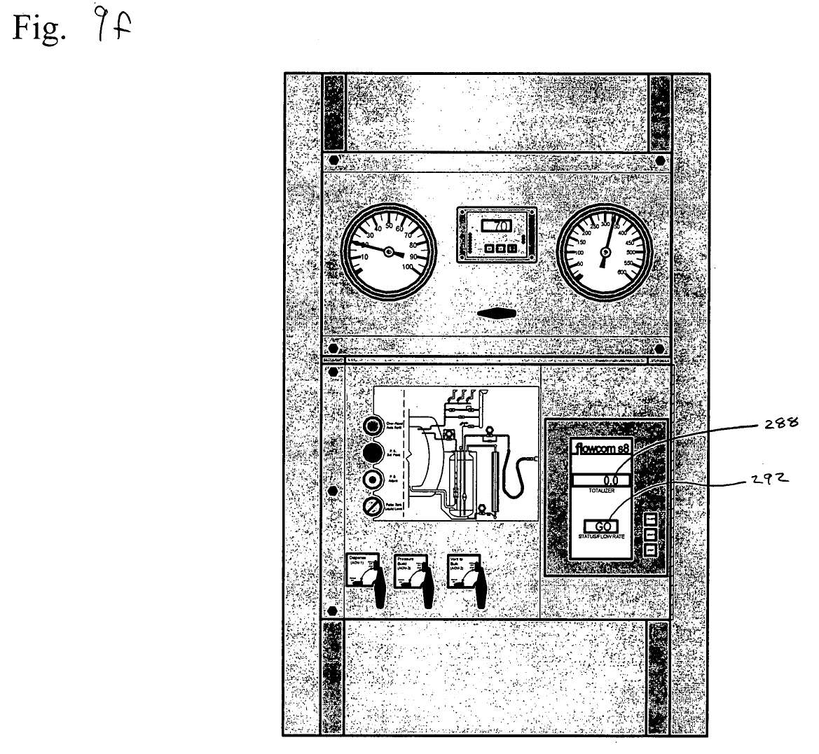

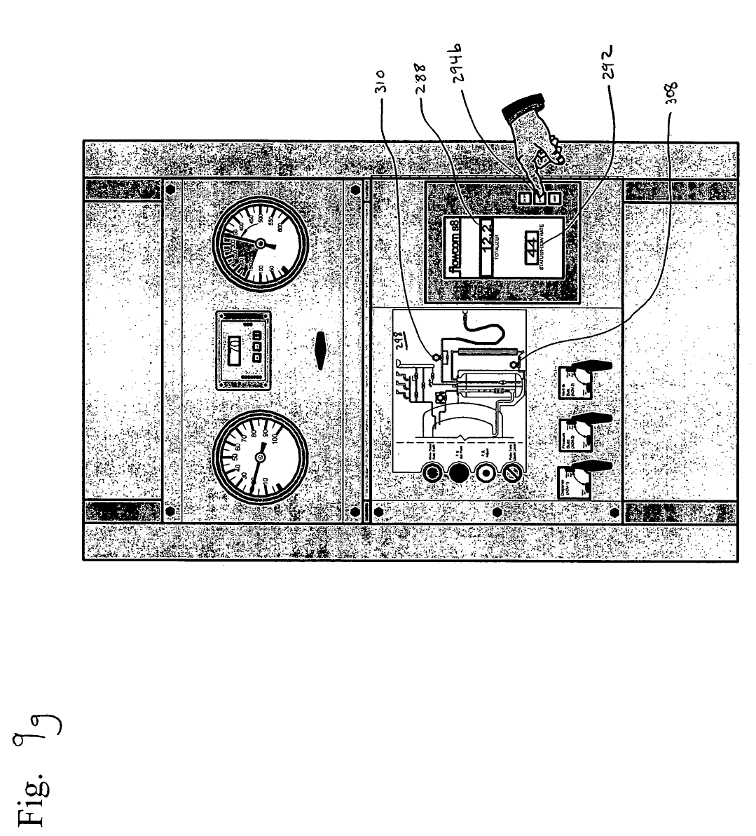

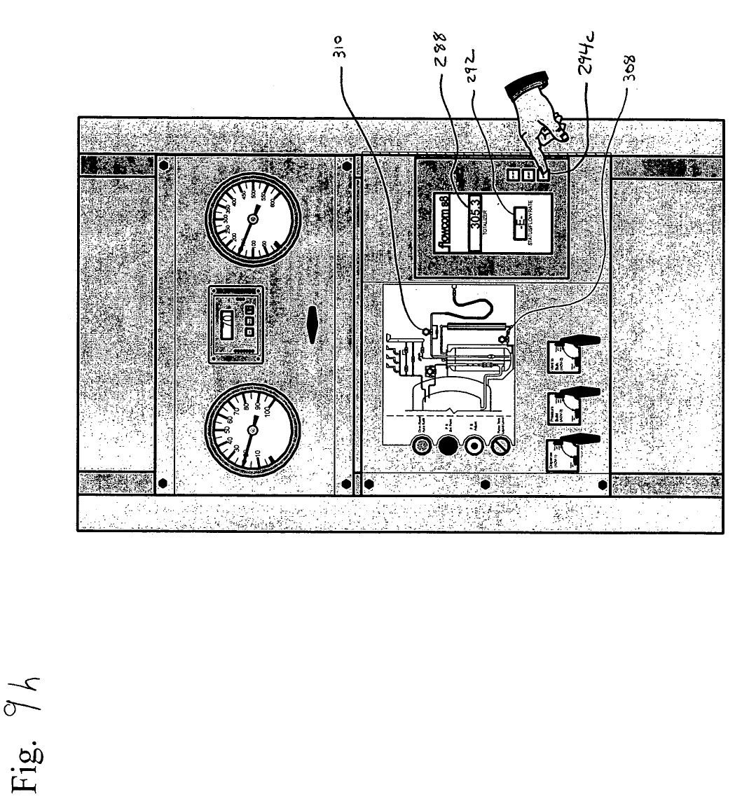

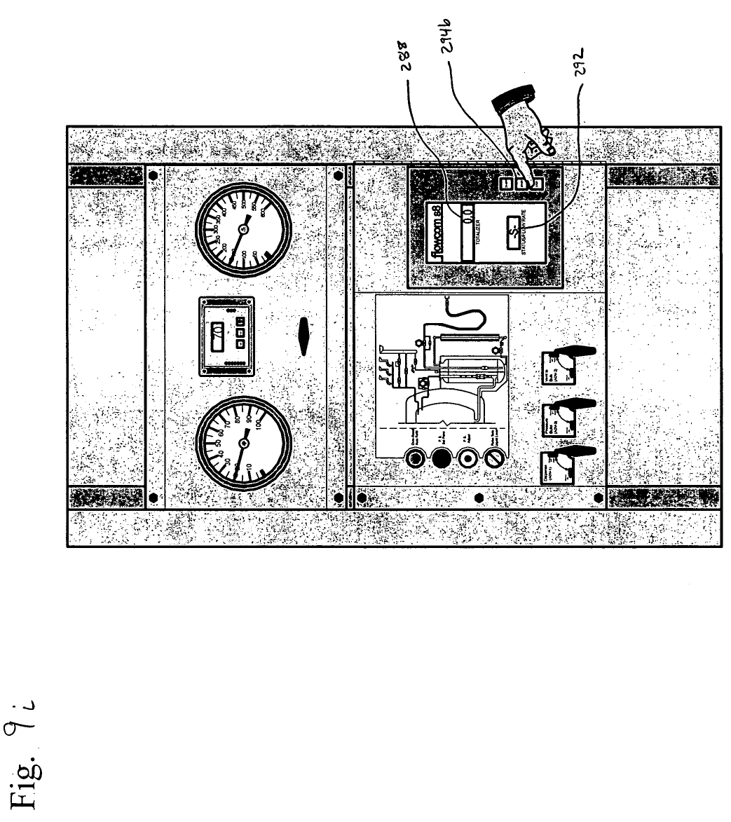

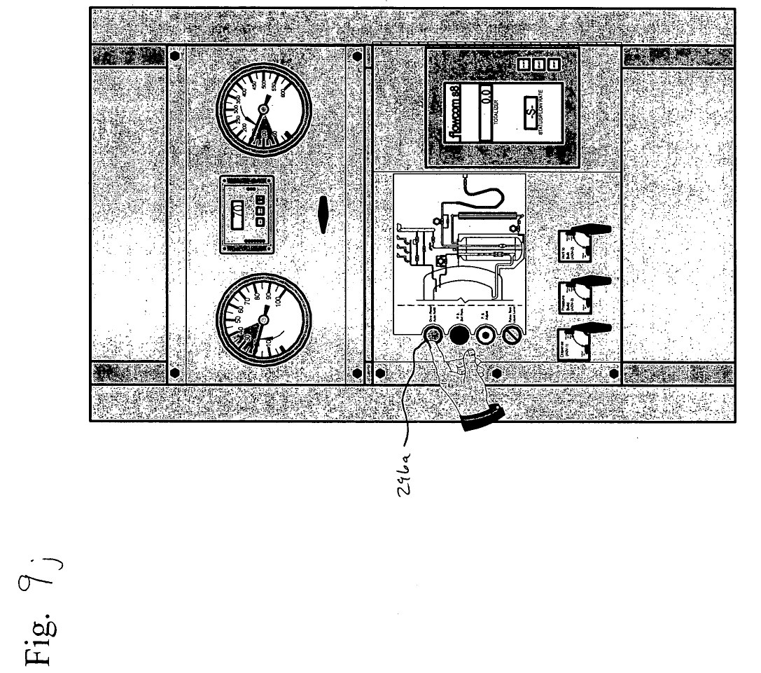

A second embodiment of the present invention is indicted in general at 210 in FIG. 7. As with the first embodiment, the second embodiment features a jacketed bulk tank 212 that provides cryogenic liquid via supply line 232 to a pulse tank or sump 214. In addition, finned, pressure-building heat exchangers (preferably two) 222 and a dispensing hose 224 (preferably around ¾ inches in diameter) communicate with sump 214 to pressurize it and dispense cryogenic liquid to receiving tank 225, respectively. Indeed, with the exception of the components discussed below, the construction of the second embodiment of FIGS. 7 through 9j is the same as the first embodiment of FIGS. 1 through 6m.

The second embodiment of the system features a vent circuit or stack, indicated in general at 233 in FIG. 7, that communicates with the head space of bulk tank 212. The vent stack is provided with emergency pressure relief valves 234 that automatically open to vent the bulk tank when the pressure therein reaches a predetermined maximum level. In addition, the vent stack includes a muffler 235 that communicates with the head space of the bulk tank through main storage road relief valve 236 and main storage vent valve 237, both of which are preferably manually operated valves. The muffler preferably is constructed from a steel tube filled with brass wool. The brass wool slows the gas flow through the muffler so that is quieted. The sump tank vent line 239 and valve 240 communicate with the muffler 235 as well.

As illustrated in FIG. 7, the second embodiment of the system of the present invention also differs from the first embodiment in that the sample tube 242 communicates with the bottom of the sump instead of the supply line 232. In addition, the automated pressure building valve 244 has been moved so that it is positioned between the inlet of the heat exchangers 222 and the liquid side of sump 214.

The vent return line 254 of FIG. 7 is provided with a road relief circuit that by-passes vent return valve 252. The road relief circuit includes a road relief sump valve 253, which preferably is manually operated, and a check valve 255. In addition, the horizontal portion 264 of dip tube 262 features hose drain check valve 276, which by-passes dispensing valve 266.

The operation of the system of FIG. 7 will now be explained with reference to FIGS. 8a through 8k. In addition, the method of operating the system of FIG. 7 will be described with reference to FIGS. 9a through 9j which, as will be explained below, illustrate the control panel of the system. The control panel of FIGS. 9a through 9j communicate with the system controller, which also controls the automated valves of the system.

The condition of the system of FIG. 7 upon arrival at a dispensing location is illustrated in FIG. 8a. As with FIGS. 6a through 6m, the light shading in FIGS. 8a through 8k represents cryogenic liquid while the dark shading represents cryogenic vapor. In the arrival condition illustrated in FIG. 8a, road relief valves 236 and 253 are open. All other system control valves are closed. If the pressure within the bulk tank 212 is above the road relief set point of relief valve 278, cryogenic vapor will be venting from muffler 235. The liquid level in sump 214 will be at or generally near the 100% full level.

The control panel of the system of FIGS. 7 and 8a through 8k is illustrated in FIG. 9a. The upper portion of the control panel includes a bulk tank pressure gauge 282, a sump tank pressure gauge 284 and a bulk tank liquid level gauge 286. The bulk tank liquid level gauge displays the liquid level in the bulk tank in % full. The lower right portion of the control panel features a digital totalizer display 288 and a status display 292 as well as on/off, start and stop buttons, indicated at 294a, 294b and 294c, respectively. The lower left portion of the control panel includes auto refill button 296a, pressure building set point button 296b, pressure building adjust knob 296c and pulse tank or sump liquid level button 296d. A schematic panel 298 is provided to the right of buttons and knob 296a-296d and features lights that illuminate to communicate the operational status of the system. Pneumatic override switches 302 are provided beneath the buttons 296a-296d and schematic panel 298 and override the control system to permit the automated valves be opened and closed manually. The switches 302 are normally in the manual off (auto) position.

FIG. 9a illustrates the control panel in the arrival condition described with respect to FIG. 8a. The pressure of the bulk tank 212 of FIG. 8a is below 25 psi and it is 70% full. The pressure in the sump is within 5 psi of the pressure in the bulk tank. The totalizer 288 displays zero if the last delivery was cleared and the status display 292 indicates an “S” meaning the system is in a standby or ready condition.

After arrival, the user must isolate the sump of the system as the first step of the dispensing or delivery process. This is accomplished by manually closing the road relief valves 236 and 253, as illustrated in FIG. 8b. Next, the dispensing hose 224 is attached to the receiving tank 225, as illustrated in FIG. 8c. The nozzle dispensing valve 268 is closed at this point. Receiving tank 225 preferably includes a pressure gauge 304 and vent valve 306. If the pressure therein is above 220 psi, it should be vented via vent valve 306.

The liquid level in the sump should be checked next. This is accomplished, as illustrated in FIG. 9b, by pressing start button 294b on the control panel. The liquid level will then be indicated by the totalizer display 288 in terms of % full. The status display 292 will change from “S” to “L” indicating that the liquid level is being displayed.

The pressure building set point may be checked by pressing the pressure building set point button 296b, as illustrated in FIG. 9c. The system pressure building setting, that is, the pressure to which the sump is pressurized prior to dispensing, is displayed on totalizer 288, as illustrated in FIG. 9c (where the set point is 300 psi). The pressure building set point may be adjusted by turning the pressure building adjust knob 296c, as illustrated in FIG. 9d where the system pressure building setting has been adjusted to 325 psi, as indicated by totalizer 288. The pressure building setting is preferably set approximately 100 psi above the noted receiving tank pressure.

Pressure building is commenced by the user pressing the start button 294b, as illustrated in FIG. 9e. A light 308 corresponding to the location of the pressure building valve illuminates on schematic panel 298 to indicate that pressure building has begun. The totalizer 288 indicates the rising pressure in the sump as pressure building proceeds.

As illustrated in FIG. 8d, the automated pressure building valve 244 opens in response to the user pressing the start button (FIG. 9e). The nozzle valve 268 is preferably opened at this time as well. With the pressure building valve 244 open, cryogenic liquid flows through the heat exchangers 222 and is vaporized. The resulting vapor is directed to the head space of the sump so that the sump is pressurized.

When the pressure building set point is reached, the pressure building valve is automatically closed and the light 308 of FIG. 9e turns off. In addition, “GO” is displayed on the control panel status display 292, as illustrated in FIG. 9f. The totalizer 288 also resets to zero.

The user then presses the start button 294b, as illustrated in FIG. 9g, to start the dispensing or delivery of cryogenic liquid. As illustrated in FIG. 8e, dispensing valve 266 opens so that cryogenic liquid flows from the sump 214 to the receiving tank 225 through dip tube 262 and 264 and dispensing hose 224 due to the pressure difference between the two tanks. As illustrated in FIG. 9g, light 310 of schematic panel 298, which corresponds to the position of the dispensing valve, illuminates to indicate that dispensing is in progress. The flow rate is indicated on the status display 292 of the control panel in gallons/minute and can exceed 40 gallons/minute at the start of dispensing. The growing amount of cryogenic liquid delivered is indicated on the totalizer 288.

During delivery, the cold cryogenic liquid, with the high pressure push behind it, enters the relatively warm receiving tank 225 and collapses the pressure head therein so that the pressure decreases in the receiving tank along with the pressure decrease in the sump. As a result, the flow between the two tanks is maintained at a relatively constant rate for a period of time. As with the system of FIGS. 1 through 6m, however, the system of FIGS. 7 through 9j features a controller that communicates with the control panel as well as meter 278 of FIG. 8e. When the controller detects a drop in the flow rate of cryogenic liquid out of the sump via meter 278, it automatically opens pressure building valve 244, as illustrated in FIG. 8e, so that pressure building in the sump resumes. When the pressure building valve is opened, the light 308 on the schematic panel 298 of FIG. 9g again illuminates.

The flow rate drops off from approximately 40 gallons/minute to 20 gallons/minute as the amount of cryogenic liquid delivered from the sump approaches 300 liters and the sump is nearly empty, as illustrated in FIG. 8f. If the receiving tank requires more the amount of cryogenic liquid in the sump, the user may stop the flow of liquid from the sump by manually closing the nozzle valve 268 or by pressing the stop button on the control panel, as indicated at 294c in FIG. 9h, so that the dispensing valve 266 of FIG. 8f is automatically closed. The user may then refill the sump with liquid via the auto refill procedure described below. If the receiving tank 225 becomes full during delivery, it will signal the delivery system, in the manner described above with regard to the first embodiment of the system, so that the dispensing valve 266 and pressure building valve 244 are automatically closed and the delivery of cryogenic liquid is automatically terminated. The hose pressure and liquid therein then is released and drains back into the sump through check valve 276. The nozzle valve 268 is then manually closed, if not done so already, and the hose is stowed.

Lights 308 and 310 on the schematic panel 298 of FIG. 9h are extinguished when the dispensing and pressure building valves are closed. The delivery total is displayed on the totalizer display 288 of the control panel. To end the delivery, the user presses the stop button 294c and holds it until “E” appears on the status display 292. A printer may be placed in communication with the controller of the system so that a delivery ticket listing the amount of cryogenic liquid delivered may be printed. The totalizer display 288 may be cleared by pressing the stop button 294b, as illustrated in FIG. 9i. The status display 292 then indicates “S”.

A user may automatically refill the sump by pressing auto refill button 296a, as illustrated in FIG. 9j. This causes the vent return valve 252 to open, as illustrated in FIG. 8g so that the pressure in the sump 214 drops and pressure in the bulk tank 212 increases. Next, the user manually opens the main storage vent valve 237, as illustrated in FIG. 8h, so that the vapor escapes the bulk tank through muffler 235 and the pressure in the bulk tank 212 drops to nearly 25 psi. The road relief valves 236 and 253 are next opened, as illustrated in FIG. 8i. The user then proceeds to travel to the next dispensing or delivery location. The sump 214 will then automatically refill with cryogenic liquid from bulk tank 212 through check valve 238 during travel until the apertures 248 of pipe 246 are covered, as illustrated in FIGS. 8j and 8k. More specifically, once the apertures are covered with liquid, the pressure within the sump 214 will then increase so that supply check valve 238 is closed. The open road relief valves keep the sump tank pressure at a level acceptable for road travel.

The system of the present invention thus offers a mobile cryogenic dispensing system that offers the benefits of a low pressure bulk tank and rapid pressure building in a sump tank and avoids the disadvantages of having a pump. The system is simple to use due to its automated operation. The system offers tremendous flexibility and may be used to quickly and efficiently refill multiple cryogenic liquid cylinders at a use point.

The system of the present invention permits single-hose no loss filling to a liquid cylinder as described in commonly assigned U.S. Pat. No. 5,787,942 to Preston et al. The Preston et al. '942 patent also provides an example of a cryogenic liquid cylinder that may be refilled using the system of the present invention.

While the preferred embodiments of the invention have been shown and described, it will be apparent to those skilled in the art that changes and modifications may be made therein without departing from the spirit of the invention, the scope of which is defined by the appended claims.

1. A system for dispensing cryogenic liquid to a use point comprising:
a) a bulk tank containing a supply of cryogenic liquid;
b) a sump;
c) a supply line extending between said bulk tank and said sump so that said sump receives cryogenic liquid from said bulk tank,
d) a supply valve in circuit with said supply line, said supply valve closing in response to a pressure increase in the sump;
e) a heat exchanger in communication with the sump, said heat exchanger selectively receiving and vaporizing a portion of cryogenic liquid from the sump and directing a resulting vapor to the sump so as to increase the pressure therein; and
f) a dispensing hose in communication with the sump.

2. The system of claim 1 further comprising a frame upon which said bulk tank and said sump are mounted, said frame adapted to be mounted on a vehicle.

3. The system of claim 1 further comprising a strainer in circuit between the bulk tank and the supply valve.

4. The system of claim 3 wherein the supply valve and strainer are positioned within the sump.

5. The system of claim 1 wherein the supply valve is a check valve.

6. The system of claim 1 further comprising a sample line in communication with the supply line and selectively in communication with the ambient atmosphere.

7. The system of claim 1 wherein the supply valve is positioned within the sump.

8. The system of claim 1 wherein the bulk tank and the sump are jacketed.

9. The system of claim 1 further comprising a vent return line extending between the sump and the bulk tank and a pipe in circuit between the supply valve and said vent return line, said pipe including at least one aperture through which cryogenic liquid may enter said sump.

10. The system of claim 9 further comprising a vent return line valve positioned within said vent return line.

11. The system of claim 1 further comprising a pressure building valve in circuit between the outlet of the heat exchanger.

12. The system of claim 11 wherein said pressure building valve is automated and further comprising a sensor for determining a liquid level of said sump and a controller in communication with the sensor and the pressure building valve, said controller automatically opening the pressure building valve when the liquid level with the sump reaches a predetermined level as detected by the liquid level sensor.

13. The system of claim 12 wherein the sensor for determining the liquid level of the sump is a differential pressure gauge.

14. The system of claim 1 further comprising a controller, a pressure sensor in communication with the sump and the controller and a automatic dispensing valve in communication with the dispensing hose and said controller, said controller opening the dispensing valve when the pressure within sump reaches a predetermined value as detected by the pressure sensor.

15. The system of claim 1 further comprising a sump vent line in communication with a head space of the sump and the ambient atmosphere and a sump vent valve positioned within the sump vent line.

16. The system of claim 15 wherein said sump vent valve is automated and further comprising a sensor for determining a liquid level of said sump and a controller in communication with the sensor and the sump vent valve, said controller automatically opening the sump vent valve when the liquid level with the sump reaches a predetermined level as detected by the liquid level sensor.

17. The system of claim 16 wherein the sensor for determining the liquid level of the sump is a differential pressure gauge.

18. The system of claim 1 further comprising a dip tube and said dispensing hose communicates with the liquid side of the sump through the dip tube.

19. The system of claim 18 further comprising a meter positioned within the dip tube.

20. The system of claim 19 further comprising a temperature sensor positioned within the dip tube.

21. A method of dispensing cryogenic liquid comprising the steps of:
a) providing a bulk tank containing a supply of cryogenic liquid, a sump and a supply valve in circuit between the bulk tank and the sump;
b) transferring cryogenic liquid to the sump from the bulk tank through the supply valve;
c) pressurizing the cryogenic liquid within the sump so that the supply valve is closed and the cryogenic liquid in the sump is pressurized to a delivery pressure; and
d) dispensing the pressurized cryogenic liquid from the sump to a use point.

22. The method of claim 21 wherein step c) includes vaporizing a portion of the cryogenic liquid in the sump.

23. The method of claim 21 further comprising the step of straining the cryogenic liquid before it travels through the supply valve.

24. A system for dispensing cryogenic liquid to a use point comprising:
a) a bulk tank containing a supply of cryogenic liquid;
b) a sump;
c) a supply line extending between said bulk tank and said sump so that said sump receives cryogenic liquid from said bulk tank;
d) a supply valve in circuit with said supply line, said supply valve closing in response to a pressure increase in the sump; and
e) a dispensing hose in communication with the sump.

25. The system of claim 24 further comprising a vent return line extending between the sump and the bulk tank and a pipe in circuit between the supply valve and said vent return line, said pipe including at least one aperture through which cryogenic liquid may enter said sump.

26. The system of claim 24 wherein said supply valve is a check valve.

27. The system of claim 24 further comprising pressure building means in communication with the sump.

28. The system of claim 24 further comprising a vent circuit in communication with the bulk tank.

29. The system of claim 28 wherein the vent circuit includes a muffler.

30. The system of claim 29 wherein in the vent circuit also communicates with the sump.
